(19) United States
(12) Patent Application Publication
(10) Pub. No.: US 2013/0080319 A1
(43) Pub. Date: Mar. 28, 2013

(54) SYSTEMS AND METHODS FOR EMBEDDED VIRTUAL SHOPPING CARTS

(71) Applicant: Permission Interactive, Inc., San Diego, CA (US)

(72) Inventor: Robert Bruce Greenstone, San Diego, CA (US)

(73) Assignee: PERMISSION INTERACTIVE, INC., San Diego, CA (US)

(21) Appl. No.: 13/627,658

(22) Filed: Sep. 26, 2012

Related U.S. Application Data
(60) Provisional application No. 61/540,313, filed on Sep. 28, 2011.

(51) Int. Cl. G06Q 20/22

(52) U.S. Cl. 705/39

(57) ABSTRACT

Systems and methods for providing embedded payment functionality, such as a virtual shopping cart. In an embodiment, configuration data is received. The configuration data may comprise product data and up-sell data. A uniform resource locator (URL) that is associated with the configuration data is generated, and Hypertext Markup Language (HTML) code comprising the URL is generated. The HTML code is capable of being inserted or embedded within a HTML document. In addition, a plurality of user interfaces may be dynamically generated based on the configuration data. The plurality of user interfaces comprise a payment interface comprising inputs for payment information, and one or more up-sell interfaces comprising inputs for selecting one or more up-sell offers.

### PRIORITY

This application claims priority to U.S. Provisional Patent App. No. 61/540,313, filed on Sep. 28, 2011, and titled “System, Method, and Computer Readable Medium for Providing a Virtual Shopping Cart,” the entirety of which is hereby incorporated herein by reference.

### BACKGROUND

1. Field of the Invention

The invention is generally directed to ecommerce microsites, and, more particularly, to a manageable, embeddable virtual shopping cart with up-sell capabilities.

2. Description of the Related Art

Direct-response marketing is designed to generate an immediate response from consumers. It differs from more traditional forms of marketing in that there are no intermediaries (e.g., retailers) between the buyer and seller. Direct-response marketing also differs from more traditional sales models in that direct-response marketing is often more granular. Each transaction may be “atomic” in that it comprises a single item. Accordingly, each consumer response and purchase can be measured and attributed to an individual advertisement (e.g., television advertising, radio advertising, print advertising, mail, telemarketing, catalogs, the Internet, etc.).

The Internet analogue to direct-response marketing is the ecommerce microsite. An ecommerce microsite is a website landing page with a built-in shopping cart that can close a sale with a minimal number of clicks (e.g., a single click). They can be implemented to be compatible with any networked computing device, including, but not limited to, desktop computers, laptop computers, tablet computers, smart phones or other mobile phones, and the like. Microsites with a post-transaction sales up-sell funnel have the ability, directly after an initial transaction is consummated, to present consumers with related items in a sequential, intelligent manner that encourages consumers to add items to their purchases in greater quantities than traditional shopping carts. Because a microsite focuses a consumer's attention on a product which he or she is specifically interested in and generally require fewer clicks to complete a purchase, microsites close a higher percentage of sales and, when accompanied by an up-sell funnel, achieve higher average order values (AOV), resulting in lower consumer acquisition costs and higher profits for marketers.

This is in contrast to traditional virtual shopping carts, which may have tens to thousands of items in them, and for which five to ten clicks may be necessary to complete a transaction. Not surprisingly, compared to ecommerce microsites, traditional multiple-page websites with multiple-step checkout processes tend to have low conversion rates and high transaction abandonment rates.

Because marketers are interested in increasing conversion rates and AOV, and decreasing instances of transaction abandonment, they would generally be interested in utilizing microsites with up-sell funnels for all or a substantial portion of their products. However, conventionally, each microsite must be individually generated and maintained. Thus, a developer would have to build a microsite with different creative and an integrated or built-in shopping cart for each product. Such a process is difficult, expensive, and time-consuming to scale for large numbers of product offerings.

Alternatively, instead of generating each microsite with its own shopping cart, marketers may attempt to increase the efficiency of the microsite generation process by centralizing and off-loading the shopping cart process from the microsite landing page. In this case, typically, a microsite landing page will comprise the marketer's product offering or “creative” comprising one or more media elements related to the product (e.g., images, videos, sound, embedded Flash™ objects, etc.) and a button or link for purchasing the product. A consumer must click and follow the purchase button or link before beginning the transaction process. This will retrieve a second webpage, which may be externally hosted by a third-party billing application or other centralized application, and which allows the consumer to enter payment information and consummate the transaction. In such a configuration, a single virtual shopping cart can be utilized for all products, and therefore, can be easily and inexpensively scaled for a large number of product offerings. However, the configuration adds at least one additional click to an entirely different URL for each transaction process, which results in a decrease in the conversion rate. Essentially, as the number of clicks required to complete a transaction increases and/or as time lag increases (e.g., caused by the need to retrieve and load an entirely different URL), the opportunity for abandonment increases, and consequently the rate of conversion decreases.

Accordingly, marketers are faced with choosing between either (1) the time-consuming and expensive process of building a shopping cart for each product, or (2) the efficient process of relying on a single, centralized shopping cart for all products while accepting the accompanying decrease in conversion rates. Currently, most marketers have opted for the latter. Consequently, despite the advantages of microsites with integrated shopping carts (e.g., increased conversion rates), the cost of scaling such microsites for large virtual retailers has impeded their utilization. Furthermore, the comparatively low cost of the separate, centralized virtual shopping cart model has resulted in its widespread adoption over the microsite model for the vast majority of ecommerce sites.

It would be advantageous if marketers could easily, inexpensively, and efficiently utilize ecommerce microsites with integrated and centralized virtual shopping carts on a large scale for all or substantially all of their product offerings. Online marketers could experience higher conversion rates, higher AOV, lower customer and sales acquisition costs, and increased profitability. Furthermore, consumers could save time by being able to more quickly and easily find and purchase specific products, and find related products.

### SUMMARY

Accordingly, systems and methods are disclosed to address the deficiencies in the art currently impeding efficient utilization of ecommerce microsites. For instance, the disclosed systems and methods may allow marketers to quickly and inexpensively generate integrated virtual shopping carts for their microsites, without any (or any significant) drain on IT resources.

In an embodiment, a system for providing an embedded virtual shopping cart or other purchasing functionality is disclosed. The system comprises: at least one hardware processor; and at least one executable software module that, when executed by the at least one hardware processor, receives configuration data, wherein the virtual shopping cart data comprises product data and up-sell data, generates a uniform resource locator (URL) that is associated with the configuration data, generates Hypertext Markup Language (HTML) code comprising the URL, wherein the HTML code is capable of being inserted within a HTML document, and, dynamically generates a plurality of user interfaces based on the configuration data, wherein the plurality of user interfaces comprise a payment interface comprising inputs for payment information, and one or more up-sell interfaces comprising inputs for selecting one or more up-sell offers.

In an additional embodiment, a method for providing an embedded virtual shopping cart is disclosed. The method comprises, by at least one hardware processor: receiving configuration data, wherein the configuration data comprises product data and up-sell data; generating a uniform resource locator (URL) that is associated with the configuration data; generating Hypertext Markup Language (HTML) code comprising the URL, wherein the HTML code is capable of being inserted within a HTML document; and dynamically generating a plurality of user interfaces based on the configuration data, wherein the plurality of user interfaces comprise a payment interface comprising inputs for payment information, and one or more up-sell interfaces comprising inputs for selecting one or more up-sell offers.

### BRIEF DESCRIPTION OF THE DRAWINGS

The details of the present invention, both as to its structure and operation, may be gleaned in part by study of the accompanying drawings, in which like reference numerals refer to like parts, and in which:

FIG. 1 illustrates a system for generation, management, and utilization of embedded virtual shopping carts and/or ecommerce microsites, according to an embodiment;

FIGS. 2-9 illustrate high-level flowcharts for processes that may be implemented by various embodiments of a virtual shopping cart, according to various embodiments;

FIG. 10 illustrates a high-level flowchart for a payment card authorization process, according to an embodiment;

FIG. 11 illustrates an embedded virtual shopping cart, according to an embodiment;

FIG. 12 illustrates a high-level flowchart for generating an embeddable virtual shopping cart, according to an embodiment;

FIG. 13 illustrates a high-level flowchart for an example operation of a virtual shopping cart, according to an embodiment; and

FIG. 14 illustrates a processing system on which one or more of the processes described herein may be executed, according to an embodiment.

### DETAILED DESCRIPTION

In an embodiment, systems and methods are disclosed for facilitating the process of integrating a virtual shopping cart into the landing page or other page of a microsite.

System Overview

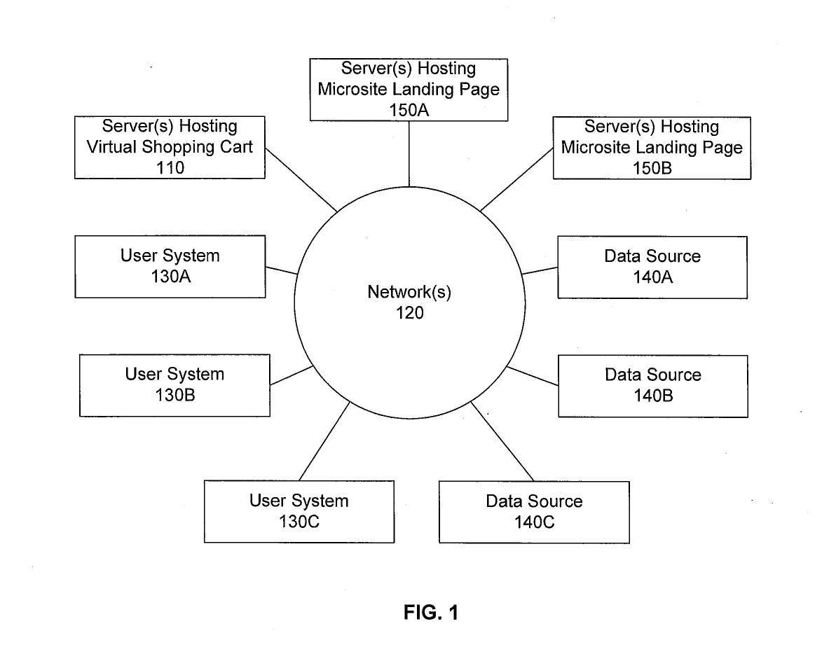

FIG. 1 illustrates an example system for generating, managing, and utilizing an embedded purchasing functionality, referred to herein as a shopping cart, and/or ecommerce microsite, according to an embodiment. The system may comprise a set of one or more servers 110 which host and/or execute one or more of the various functions and/or software modules described herein, such as the disclosed virtual shopping cart. In addition, the server(s) 110 are communicatively connected to one or more user systems 130—and, in some embodiments, one or more data sources 140—via one or more network(s) 120. User system(s) 130 may also be connected to one or more server(s) which host ecommerce microsites via network(s) 120. In an alternative embodiment, server(s) 150 and 110 may be one in the same or commonly operated. The network(s) 120 may comprise the Internet, and server(s) 110 and/or 150 may communicate with user system(s) 130 through the Internet using standard transmission protocols, such as HyperText Transfer Protocol (HTTP), Secure HTTP (HTTPS), File Transfer Protocol (FTP), and the like. In an alternative embodiment, server(s) 110 and/or 150 may not be dedicated servers, and may instead be cloud instances, which utilize shared resources of one or more servers. Furthermore, while FIG. 1 illustrates the server(s) 110 and 150 being connected to various systems through a single set of network(s) 120, it should be understood that the server(s) 110 and 150 may be connected to the various systems via different sets of one or more networks. For example, the server(s) 110 and 150 may be connected to user systems 130 via the Internet, but may be connected to one or more of the data sources 140 via an intranet. It should also be understood that user system(s) 130 may comprise any type or types of computing devices capable of wired and/or wireless communication, including without limitation, desktop computers, laptop computers, tablet computers, smart phones or other mobile phones, servers, game consoles, televisions, set-top boxes, electronic kiosks, and Automated Teller Machines. In addition, while only three user systems 130A-C, three data sources 140A-C, and two sets of server(s) 150 are illustrated, it should be understood that the network may comprise any number of user systems, data sources, and sets of one or more microsite-hosting servers.

Server(s) 110 may comprise web servers which host one or more websites or web services. In embodiments in which a website is provided, the website may comprise one or more user interfaces, including, for example, webpages generated in HyperText Markup Language (HTML) or other language. The server(s) 110 transmit or serve these user interfaces in response to requests from user system(s) 130. These user interfaces may be served in the form of a wizard, in which case two or more user interfaces may be served in a sequential manner, and one or more of the sequential user interfaces may depend on the user's interaction with one or more preceding user interfaces. Similarly, server(s) 150 may also comprise web servers which host one or more ecommerce microsites.

The requests to server(s) 110 and 150 and the responses from server(s) 110 and 150, including the user interfaces (and microsites in the case of server(s) 150), may both be communicated through network(s) 120, which may include the Internet, using standard communication protocols (e.g., HTTP, HTTPS). These user interfaces or web pages may comprise a combination of content and elements, such as text, images, videos, animations, references (e.g., hyperlinks), frames, inputs (e.g., textboxes, text areas, checkboxes, radio buttons, drop-down menus, buttons, forms, etc.), scripts (e.g., JavaScript), and the like. The server(s) may also respond to other requests from the user system(s) 130. For example, a user system may submit data (e.g., user data, form data, etc.) to be stored in one or more databases (not shown) locally and/or remotely accessible to the server(s) 110 and/or 150. Any suitable database may be utilized, including without limitation MySQL, Oracle, IBM, Microsoft SQL, Sybase, Access, and the like, including cloud-based database instances. Data may be sent to the server(s) 110 and/or 150, for instance, using the well-known POST request supported by HTTP. This data, as well as other requests, may be handled, for example, by a servlet or other server-side web technology executed by the server(s) 110 and/or 150.

In embodiments in which a web service is provided, the server(s) 110 may receive requests from user system(s) 130, and provide responses in eXtensible Markup Language (XML) and/or another suitable format. In such embodiments, the server(s) 110 may provide an application programming interface (API) which defines the manner in which user system(s) 130 may interact with the web service. Thus, the user system(s) 130, which may themselves be servers, can define their own user interfaces, and rely on the web service to implement the backend processes, functionality, storage, etc., described herein.

In an embodiment, one or more of the data sources 140 comprise data feeds. A data feed is a published database of information. For example, a data feed may comprise a published database of a marketer's online product offerings. In an embodiment, publication may entail a restricted publication to authenticated parties or devices, such as server(s) 110 and/or 150. Alternatively, publication may be to the public (i.e., to anyone desiring to receive the data feed).

Embedding of Virtual Shopping Cart

Conventionally, shopping carts which allow up-selling can be complicated, and therefore, require the employment of IT professionals. For example, if a customer chooses to upgrade an original purchase during the transaction process, a product identifier (e.g., stock-keeping unit (SKU)) of the originally selected item must be replaced with a product identifier of the up-sold item, and if the customer then chooses to downgrade the purchase, the product identifier must again be replaced. As a further example, up-sells may comprise a purchase which is dependent on another purchase. For instance, if an up-sell comprises a buy-one-get-one-free offer or a volume discount, the price for one purchased product may depend on the quantity of other purchased products. Thus, in embodiments which utilize an editable cart, if the user removes and/or adds a product, the cart must be able to understand and respond appropriately to update the cart, including the purchase price, according to these interdependencies.

In an embodiment, a virtual shopping cart is provided which may be easily embedded within a portion of a microsite landing page. Additionally, the virtual shopping cart may be, but is not necessarily, hosted externally from the microsite landing page (e.g., by a separate server or cloud instance). Furthermore, in an embodiment, the virtual shopping cart can be created, edited, and otherwise managed through a user-friendly interface, such as a wizard comprising one or more sequential and/or interrelated web pages (e.g., the content of one webpage may depend on the user's interaction(s) with a prior web page in the sequence). This may allow the shopping cart to be operated and managed by non-technical, back-office personnel, rather than trained IT professionals, thereby significantly reducing overhead and operating expenses, and facilitating the generation of a virtually unlimited number of embeddable shopping carts.

In an embodiment, the virtual shopping cart is embedded within a frame or other embeddable element of a HTML page representing a microsite landing page. One type of frame that may be used is an inline frame known as an “iframe.” However, although the embodiments and examples described herein will primarily be described with reference to iframes, it should be understood that in alternative embodiments, other embeddable frames or other types of tags or elements capable of inserting external content (e.g., “<frame>”, “<embed>”, etc.) may be used instead.

An iframe embeds one HTML document inside another HTML document. A simple, example iframe may comprise the following HTML code or “snippet”:

frame src=“https://www.hostname.com”></iframe>

The source parameter (i.e., “src”) is an attribute of the iframe that defines the Uniform Resource Locator (URL) for the HTML document that should be embedded by the iframe. The URL may comprise a domain name, file name, servlet name, parameter string, etc. It should be understood that other attributes may be associated with the iframe in the same manner as the source attribute, such as an alignment (“align”), a height (“height”), a width (“width”), a name (“name”), an indication of whether or not scrollbars should be displayed (“scrolling”), etc.

The URL may uniquely identify a virtual shopping cart for a particular product or domain. For example, the URL may comprise a product identifier and/or domain identifier. In an embodiment, this identifier or these identifiers may be encrypted (e.g., to prevent visitors from manipulating the identifier in the URL to view other carts) and encoded for use in a URL. The identifier(s) may correspond to a HTML document and/or be associable with a set of parameters that can be used to construct an HTML document. For example, the URL may direct a request to a servlet or other application or module which extracts the identifier(s) and performs a lookup on a database or other data structure using the identifier(s). The application may then receive parameters and/or other data as a result of the lookup and construct a HTML document using the parameters and/or data. The HTML document may be constructed utilizing a template or an active server page (e.g., ASP, JSP, etc.).

In one embodiment, the URL for the iframe may comprise both a domain identifier and a version identifier. For example, such an iframe snippet may take the form of:

<iframe
src=“https://www.hostname.com/order.aspx?domainID=[encrypted or
unencrypted domain identifier]&versionID=[encrypted or unencrypted
version identifier]”></iframe>

Alternatively, the domain identifier, version identifier, and/or any other identifier may be combined (e.g., appended to each other) and then encrypted and encoded, in which case the iframe snippet may take the form of:

<iframe src=“https://www.hostname.com/order.aspx?code= [encrypted
identifier]”></iframe>

The version identifier can be used to identify the version of the domain or virtual shopping cart widget that should be embedded. The operator of the virtual shopping cart, who is a user of the system (e.g., hosted by server(s) 110) and operator of a microsite landing page (e.g., hosted by server(s) 150A), can save and manage multiple versions of the same domain/widget. The system is able to recognize which version of the domain/widget to return or serve in response to a request to the URL in the source attribute of the iframe code by extracting the version identifier, and retrieving or constructing an HTML document corresponding to parameters and/or other data associated with the version identifier.

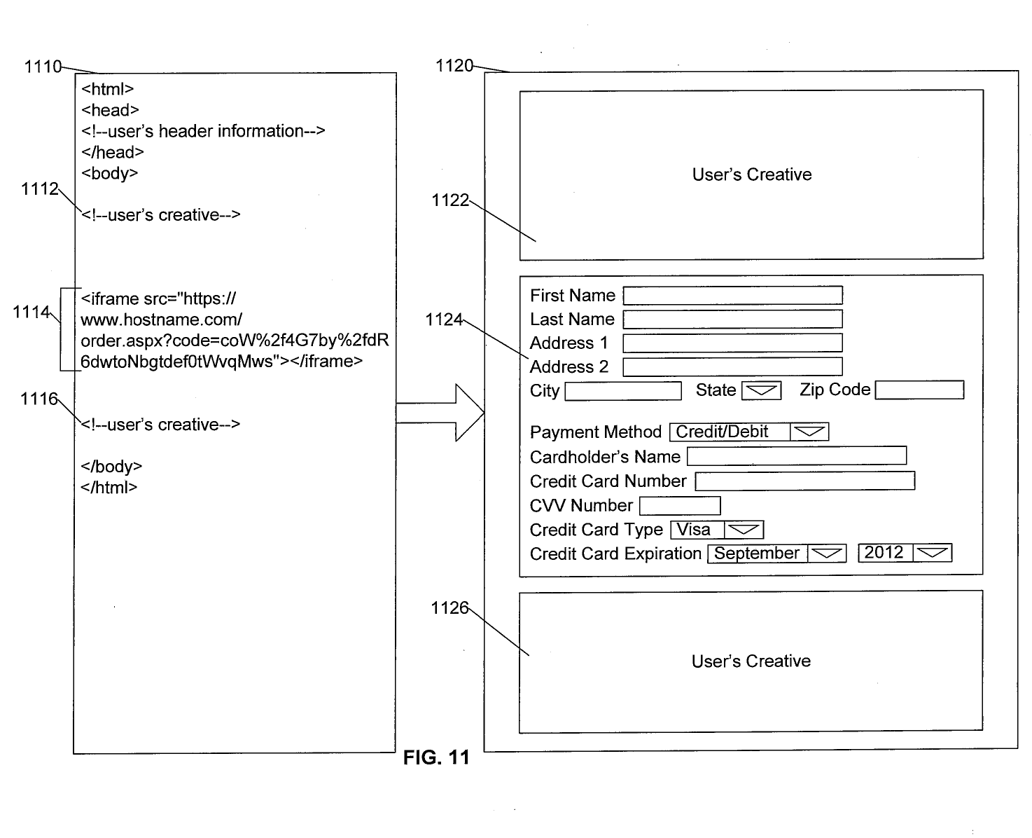

Regardless of how the particular iframe snippet is constructed, it is designed to be embedded into a user's existing HTML document. For example, a user may create a microsite landing page and insert the iframe snippet at some point within the microsite landing page. This is illustrated with reference to FIG. 11. HTML source code 1110 demonstrates how a virtual cart can be embedded within a microsite landing page. As shown, iframe snippet 1114 has been embedded within a user's creative 1112 and 1116. Although, it should be understood that iframe snippet 1114 can be positioned at any place within the body of source code 1110 (e.g., before user's creative 1112, after user's creative 1116). The user's creative may comprise any element or elements, including text, images, videos, colors, scripts (e.g., JavaScript), Flash™, hyperlinks, forms, buttons, tables, inputs, frames including other iframes, divisions, etc.

The HTML document 1110 is identified by a URL, and may be static or dynamic. When a potential consumer's device requests the URL, a server (e.g., server(s) 150A) retrieves or generates the HTML document 1110. The HTML document 1110 is then returned to the potential consumer's device and parsed by a browser application on the device. When the browser application encounters the iframe snippet, it will request the HTML document or “widget,” representing a virtual shopping cart, from the URL identified by the source attribute of the iframe (e.g., at server 110). The virtual shopping cart may also be static or dynamically generated at the time of the request. The retrieved HTML document will then be returned and inserted or “embedded” into HTML document 1110, and the combined document will be rendered by the browser application as shown in display 1120. Alternatively, it is possible that the server(s) 150A, rather than the potential consumer's browser application, could retrieve and insert the widget prior to delivering the combined document to the potential consumer's browser application. In either case, a microsite landing page hosted at one site (e.g., server(s) 150), with creative 1122 and 1126, can be embedded with a virtual shopping cart 1124 hosted at a remote or external site (e.g., server(s) 110).

Generation of Virtual Shopping Cart

In an embodiment, the system provides a high degree of configurability for the virtual shopping cart used with the microsites of a particular marketer. Using a wizard or other user interface (e.g., hosted on server(s) 110), the user may be prompted to select or specify parameters used to construct the virtual shopping cart. These parameters may not only be used to build the content of the virtual shopping cart, but also to guide its behavior, such as controlling which elements of a sales transaction are editable, and defining a process flow for up-selling. The parameters may also guide the system's behavior regarding the validity of transactions, such as when a consumer abandons the session or otherwise fails to complete the transaction. For example, if a transaction session expires after a period of inactivity, and therefore, the consumer is unable to continue the transaction, the parameters may specify that the consumer should be presented with a message on how to return to the microsite landing page, or may specify that the user should be automatically returned to the microsite landing page. As another example, in order to preclude users from exiting before a receiving a confirmation page with the intention of not completing the transaction, the parameters may specify that the confirmation should be presented on an order details page, instead of being a separate page requiring an additional click. Alternatively, one or more of these behaviors may be unchangeable system settings, rather than user-defined parameters.

Virtual shopping cart configuration and management may be driven via interaction with a central system management database (e.g., via server(s) 110), and changes to the virtual shopping cart configuration may be immediate and/or dynamic, or may be scheduled for deployment per an operator's specification. Cart behavior may also be tailored to both traditional web browser environments and mobile (e.g., iPad™) environments.

In an embodiment, the system may support real-time interactions with payment card authorization services (e.g., the Authorize.net card authorization service) using, for example, a unique series of authorization, void, and re-authorization steps to aggregate the multiple-step transaction process into a minimal number of server-side, real-time, web service interactions. In an embodiment, the virtual shopping card widget may also provide the consumer with a screen-by-screen presentation of the subtotal of the transactions accrued in the sales session, and a preview of the impact of a pending offer to the subtotal.

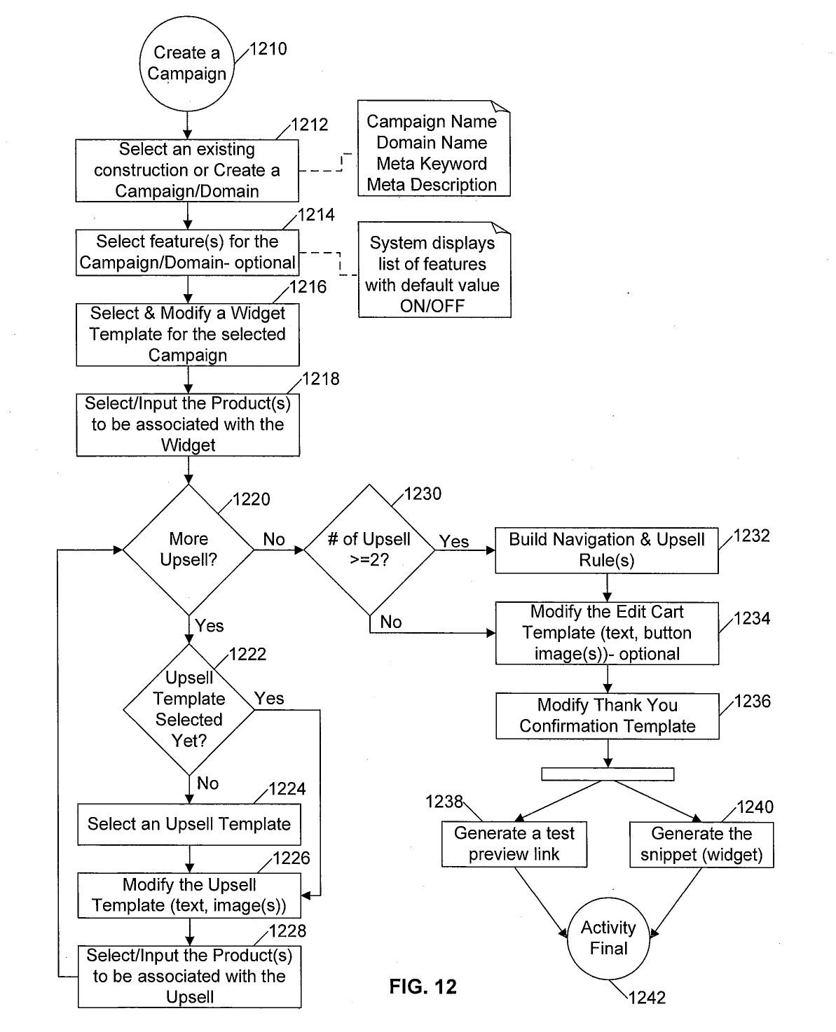

FIG. 12 illustrates a high-level flowchart for a process for generating a virtual shopping cart widget, according to an embodiment. A user may register with server(s) 110 or other servers to establish an account with the system. For example, the user may provide credentials for authenticating with the system (e.g., username and password, digital certificate, etc.), business and/or contact information (e.g., name, tax identification number, etc.), as well as additional information. Alternatively, the user may establish an account by other means, or may not be required to establish an account with the system to generate a virtual shopping cart widget.

In step 1210, a user may initiate or resume the generation of a widget, for example, by interacting with a user interface provided by server(s) 110 to select a widget-generation wizard. The wizard may comprise a sequential series of one or more screens which step the user through a stage-based generation process.

In step 1212, the user may interact with a user interface to select an existing campaign or domain (e.g., an incomplete or previously completed widget), or create a new campaign or domain (e.g., a new widget). Each campaign may be associated with one or more domains, and a domain may be associated with a campaign, and, by default, inherit the features, parameters, and other attributes of the associated campaign. If the user chooses to select an existing campaign or domain, stored campaign or domain information may be retrieved from one or more databases. The campaign information may comprise, for example, a campaign identifier, meta keywords to be used for searching or filtering campaigns or associated domains, and/or a meta description of the campaign. The domain information may comprise, for example, a campaign identifier which identifies the associated campaign, a domain identifier, meta keywords to be used for searching or filtering domains, and/or a meta description of the domain. If the user instead chooses to create a new campaign or domain, the system may prompt the user to input the campaign or domain information, and then store the inputted information in one or more databases.

In step 1214, the user may interact with a user interface to select one or more features to be associated with the campaign or domain. For example, the user interface may comprise a list of features and associated inputs (e.g., checkboxes, textboxes, drop-down menus), optionally with editable default values already entered/selected in one or more of the inputs. Selected features may be stored as parameters in association with the campaign or domain (e.g., utilizing the campaign or domain identifier). By way of illustration and not limitation, selectable features may include enablement/disablement of cart modification, order verification, order on-hold support, payment authorization, and the like.

In step 1216, the user may interact with a user interface to select and, optionally, modify a widget template for a selected campaign or domain. A plurality of selectable templates may be pre-generated by an operator of the system and/or may be generated by users of the system. In an embodiment, a template comprises a pre-generated HTML-based document (e.g., ASP, JSP), which may comprise one or more elements that can be defined by the user during the wizard process (e.g., images, text, videos, Flash, scripts, colors, fonts, inputs including free-form fields for copy or images, buttons, disclosures, disclaimers, sales tax percentage or rules, shipping options, shipping cost calculation rules, etc.). Accordingly, the wizard may prompt the user to input, select, and/or upload each definable element to be inserted into the template, and may, optionally, provide default definitions. For example, the user may specify a background color, a font color, a logo, labels for various input elements of the widget, which inputs elements should be included and/or excluded from the widget, and other content of the widget. In an embodiment, every textual, image, or other media element of the virtual shopping cart widget is virtualized (i.e., can be user-defined). These definable elements may be stored in association with a widget created according to the template. In an embodiment, pre-generated templates may comprise structures and/or aesthetics which are easily integrated into a variety of microsites.

In step 1218, the user may interact with a user interface to select, input, and/or describe one or more products to be associated with the widget. For example, for each of one or more products, the wizard may prompt the user to specify a title and/or other description (e.g., details) of the product, a price of the product, tax information applicable to the product, shipping and handling charges or other fees applicable to the product, an image of the product, and/or the like. This product information may be stored in association with the widget.

In step 1220, the user may be prompted to associate one or more up-sells with the widget. An up-sell may comprise a separate product or products from the primary product specified in step 1218. An up-sell product may be, but is not necessarily, related to the primary product. For example, an up-sell product may comprise an accessory that can be used with the primary product (e.g., a cell phone cover for a cell phone), a product that is an upgrade over the primary product (e.g., a deluxe or enhanced version of a standard product), a product that is similar to the primary product (e.g., a product that consumers who have purchased the primary product have also purchased or liked), etc. Alternatively or additionally, an up-sell may comprise an offer or change in quantity of the primary product. For example, the up-sell may comprise a volume discount, such as a get-one-free offer if a consumer purchases a certain quantity of primary products, or a discount in price for a certain quantity of primary products. It should be understood that, in a similar manner, an up-sell may also be related to a previous up-sell product, rather than the primary, landing-page product(s). An up-sell template may allow multiple up-sells to be provided on the same user interface, such that when the up-sell user interface is published to a consumer, the consumer may select one or more of the up-sells to include in the transaction (e.g., using checkboxes or radio buttons).

If the user chooses to associate an up-sell product with the widget, the process proceeds to step 1222. Otherwise, the process proceeds to step 1230. In step 1222, it is determined whether an up-sell template has been selected. The up-sell template may be the same as, part of, or separate from the template selected in step 1216. If an up-sell template has already been selected, the process may proceed to step 1226. Otherwise, if no up-sell template has been selected, the user may interact with a user interface in step 1224 to select a template for the up-sell. Additionally, in step 1226, the wizard may prompt the user to input, select, and/or upload one or more definable elements to be inserted into the up-sell template, and may, optionally, provide default definitions. These definable elements may be stored in association with the widget.

In step 1228, the user may interact with a user interface to select, input, and/or describe one or more up-sell products to be associated with the widget. For each up-sell product, the wizard may prompt the user to specify a title and/or other description of the product, a price of the product, tax information applicable to the product, shipping and handling charges or other fees applicable to the product, an image of the product, and/or the like. This up-sell product information may be stored in association with the widget.

Once the user is done specifying up-sell products to be included in the widget, the process proceeds to step 1230. In step 1230, it is determined whether or not multiple up-sells have been specified. If one or no up-sells have been specified, then the process proceeds directly to step 1234. Otherwise, if multiple up-sells have been specified, the wizard may provide the user with one or more user interfaces to build one or more navigation and/or up-sell rules in step 1232. For example, the user may interact with the user interface to specify an order for the specified up-sells, specify interdependencies between up-sells to provide intelligent branching, and the like. By way of illustration only, the user may specify that one up-sell should only be presented to a consumer if another up-sell is purchased or accepted by the consumer. For instance, if the consumer purchases one up-sell, the consumer may be presented with another related up-sell. Alternatively, the user may specify that one up-sell should only be presented to a consumer if another up-sell is rejected by the consumer. For instance, if the consumer rejects a buy-four-get-one-free up-sell offer, the consumer may be presented with a better, buy-two-get-one-free up-sell offer. The user-defined navigation and/or up-sell rules may be stored in association with the widget. In an embodiment, the wizard provides tips or instructions to guide the user through the creation of the navigation and/or up-sell rules.

In further steps, additional elements of the widget may be specified and/or enabled or disabled. For example, in step 1234, a template for editing a cart can be selected and/or modified. In step 1236, a template for confirming an order can be selected and/or modified. The wizard may prompt the user to input, select, and/or upload one or more definable elements to be inserted into such templates, and may, optionally, provide default definitions. These defmable elements may be stored in association with the widget.

Once all variable elements have been provided for the widget, the widget can be previewed in step 1238 (e.g., by selecting a preview button or link of a user interface of the wizard). Furthermore, the widget can be finalized, generated, enabled, and/or activated in step 1240, with the process ending in step 1242.

Once the widget has been generated in step 1240, the user may be provided with a URL or an iframe snippet that can be used to embed the widget into an inframe of an existing webpage, as discussed above. In an embodiment, the wizard may retrieve the domain identifier of the widget and/or other identifiers (e.g., version identifier) and embed it into a URL (e.g., in a parameter string of the URL). This URL may then be inserted as an attribute into an iframe tag to produce an iframe code. The user interface may comprise an element or object, such as a script, which copies the iframe code to the “clipboard” of the user's device for subsequent pasting. By way of illustration, the iframe snippet, including the URL with the embedded (and optionally encrypted and encoded) domain identifier as a source attribute, may look like:

<iframe src=“https://www.hostname.com/order.aspx?domID=CdzDH9LL%2fnyDIy
Yy4fX%2fSw%3d%3d&fb=c&did=635” frameborder=“0” style=“height: 900px; width: 961px;
margin-right: 0px;”></iframe>

In this example, the “frameborder” and “style” attributes may be altered by the user prior to embedding, as desired, without affecting operation of the virtual shopping cart represented by the source attribute. For instance, a user could change the height and width of the iframe to fit within a particular webpage by adjusting the style attributes.

In an embodiment, the URL may also comprise other identifiers, such as a campaign identifier, version identifier, and/or instance identifier. These identifiers may be appended separately to the parameter string of the URL, or they may be combined into a single identifier, and encrypted and encoded, such as in the following iframe snippet:

<iframe src=“https://www.hostname.com/order.aspx?code=coW%2f4G7by%2fdR6d
wtoNbgtdef0tWvqMws”></iframe>

It should be understood that there are numerous other ways to represent the identifiers, and that any number of identifiers may be represented in the parameter string of the URL. Also, in some embodiments, either a portion or all of the parameters described above (e.g., product information, up-sell information, etc.) may be received from a data feed (e.g., data source 140A), rather than from a user.

Operation of Virtual Shopping Cart

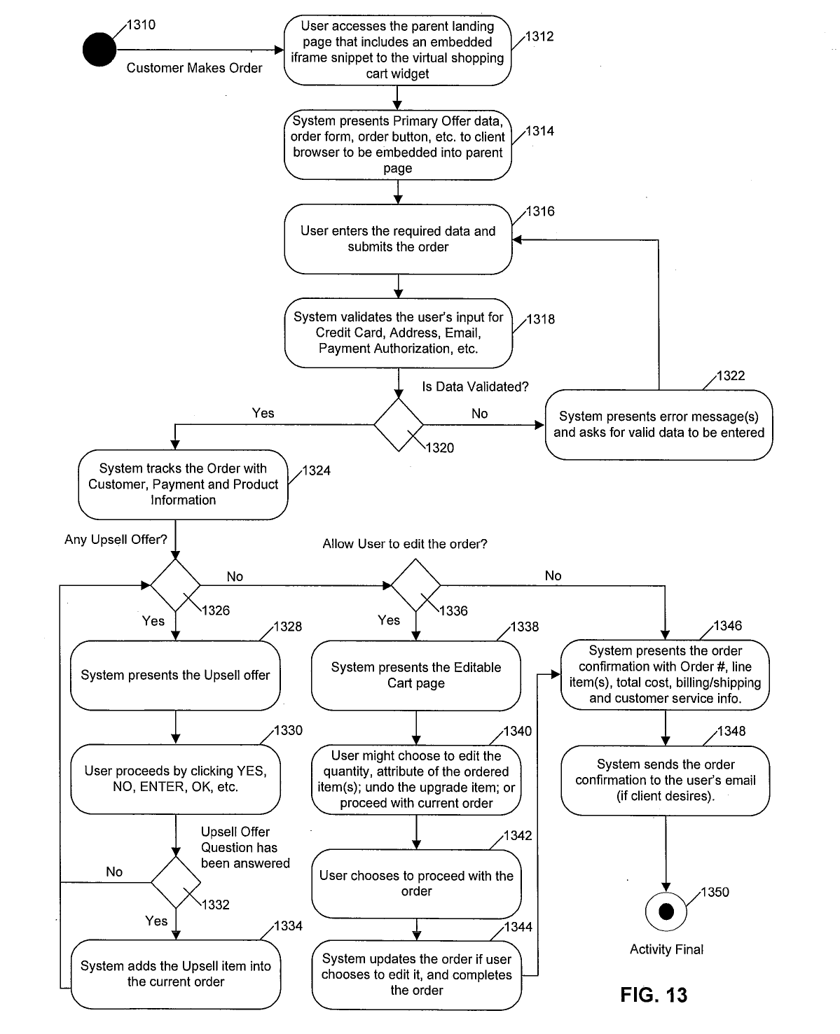

FIG. 13 illustrates a high-level flowchart for an example operation of a virtual shopping cart, according to an embodiment. In step 1312, a consumer accesses a microsite landing page. The landing page includes an embedded virtual shopping cart widget, e.g., generated according to the embodiments described elsewhere herein. The widget may be embedded using an iframe snippet, as described above.

In step 1314, the system presents product information and/or payment inputs via the embedded virtual shopping cart widget. For example, the widget may comprise primary offer data related to the primary product that is the subject of the landing page. The widget may also comprise an order form, comprising inputs for entering payment information, as well as a payment button, link, or other mechanism for submitting the payment information (e.g., to server(s) 110). This information and/or payment form may simply appear in the consumer's browser application as a portion of the microsite landing page, even though the information and/or form is hosted separately from the creative and/or other elements of the landing page. In an embodiment, the transition between the creative (and/or other elements) of the landing page and the embedded widget may be seamless, such that the consumer is unaware that the widget is embedded and externally hosted.

In step 1316, a user enters data into a payment form of the embedded virtual shopping cart widget. The user may then submit the data, e.g., using a POST request or other mechanism for transmitting the data to a remote server (e.g., server(s) 110). This data or a portion of this data may be validated in step 1318. The data may be validated prior to submission (i.e., transmission) using, for example, a client-side script. Alternatively, the data may be validated after submission using, for example, a server-side application, such as a servlet or other application or module executed by server(s) 110. In yet another alternative embodiment, a portion of the data may be validated client-side prior to submission and another portion of the data may be validated server-side after submission. The client-validated and server-validated portions may be mutually exclusive or overlapping. It should be understood that any type of data may be validated. For instance, in an embodiment, credit card data (e.g., credit card number), address information (e.g., billing and/or mailing address), an email address, payment authorization, and/or the like may be validated.

In step 1320, it is determined, by the client and/or server, whether the data was successfully validated. If the entered data failed validation (e.g., invalid credit card number, invalid address, invalid email address, etc.), in step 1322, one or more error messages are presented by the widget. The widget may also prompt the user to input valid data, for example, by presenting the same user interface as before (i.e., comprising product information and/or payment inputs) but with the error message(s) displayed. If the entered data is successfully validated, the process may proceed to step 1324.

In step 1324, the system (e.g., implemented on server(s) 110) begins tracking the order. For example, the system may generate one or more identifiers and/or data structures representing a new order. An order identifier may be associated with the consumer payment information (e.g., a consumer identifier associated with the payment information) and the product information (e.g., a product identifier associated with the primary product). These associations may be stored in memory, including in one or more databases and/or other data structures (e.g., a cached data object).

In step 1326, it is determined whether the widget is associated with one or more up-sell offers, or one or more up-sell offers are otherwise available to the widget. If not, the process proceeds to step 1336. Otherwise, the process proceeds to step 1328. In step 1328, the widget presents the first associated up-sell offer. This offer may comprise a HTML document, and may also be embedded in the microsite landing page similarly to the payment form in step 1314. Alternatively, the offer may be presented to the consumer as a separate, non-embedded webpage. In either case, the up-sell offer may be hosted by server(s) 110.

In step 1330, the consumer may interact with the user interface of the up-sell offer to either accept or decline the up-sell offer. For example, the consumer may click an “accept,” “decline,” “yes,” “no,” “ok,” “no thanks” or similarly labeled button or other input to either accept and/or decline the offer. In an embodiment, more than one up-sell offer may be presented on the same webpage or in the same iframe of the user interface. In such an embodiment, the user interface may comprise inputs (e.g., checkboxes, radio buttons, drop-downs, or other input types) with which the consumer may interact to select one and/or a plurality of up-sell offers.

In step 1332, it is determined whether the up-sell offer presented in step 1328 was accepted. If the up-sell offer was accepted, the up-sell item or items is added to the current order. For example, an up-sell identifier and/or product identifier of the up-sell product may be associated with the order identifier generated in step 1324. After the selected up-sell item is added to the order, or if the consumer declines the up-sell offer in step 1330, the process returns to step 1326 to determine whether another up-sell offer is associated with or available to the virtual shopping cart widget. If so, the widget presents this next up-sell offer to the consumer in step 1328, and the process repeats itself until all associated or available up-sell offers have been presented to the consumer.

Once all up-sell offers have been presented to the consumer, the consumer's order may be associated with the primary product as well as zero, one, or two or more up-sell offers. In step 1336, it is determined whether the widget supports editable orders. This may be a user-specified option that is enabled or disabled during generation or management of the virtual shopping cart. If editing of orders is not permitted, the process proceeds to step 1346. Otherwise, if editing of orders is permitted, the consumer is provided with an editable cart interface in step 1338. Thus, in step 1340, the consumer may or may not choose to edit the order. Editing may include modifying one or more attributes of one or more ordered items, such as removing an ordered item, changing a quantity of an ordered item, or undoing an upgrade of an ordered item. Once the consumer is satisfied with the order, he or she may choose to proceed in step 1342, for example, by selecting a “checkout” or similarly labeled button or other input. In step 1344, the system updates the order, if any modifications were made, and completes the order (e.g., by changing the status of the order). The process then proceeds to step 1346.

In step 1346, an order confirmation may be presented to the consumer. The order confirmation may comprise final order information, such as an order number, one or more line items (e.g., comprising a description, quantity, and cost for each item), a total cost of the order (e.g., including item(s) cost and any applicable taxes and shipping and handling charges), billing information, shipping information, and/or customer service information. In addition, in step 1348, an order confirmation may optionally be sent to the consumer's email address. The process ends in step 1350.

Usage of Virtual Shopping Cart

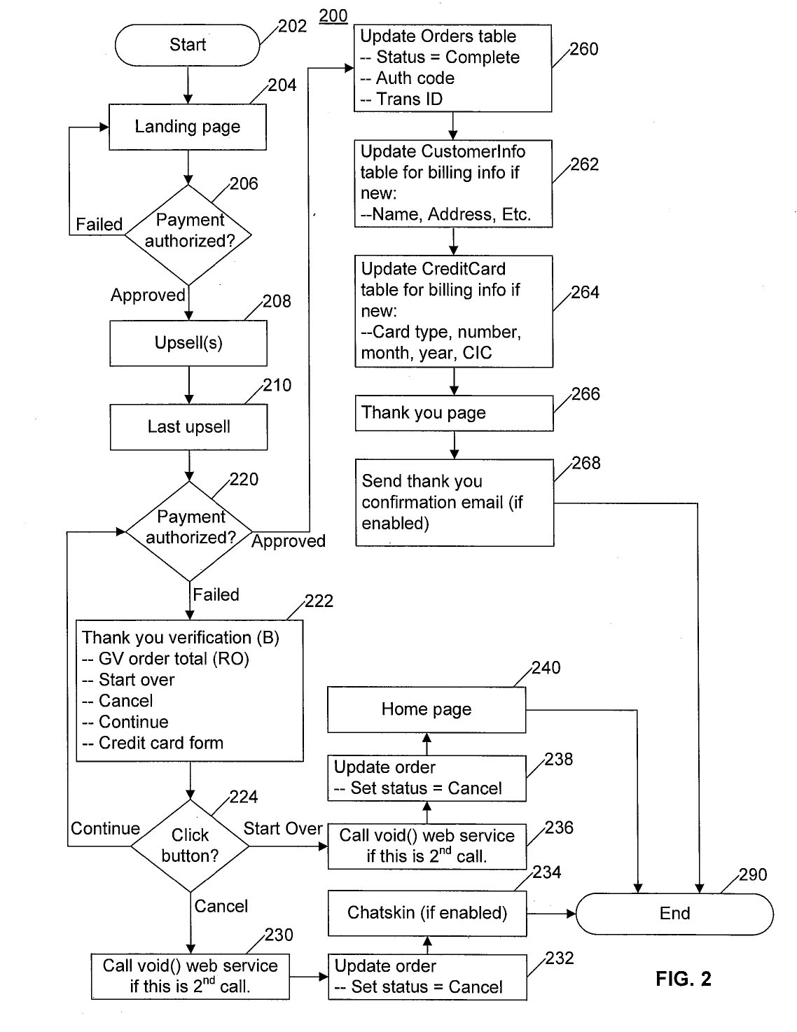

FIGS. 2-9 illustrate high-level flowcharts for processes that may be implemented by various embodiments of a virtual shopping cart widget. FIGS. 2-9 illustrate representative processes according to possible scenarios, and do not depict all possible processes in all possible scenarios. It should be appreciated that the illustrated processes may be easily modified to address other possible, non-illustrated scenarios, or to address illustrated scenarios in a different manner (e.g., according to different user-specified parameters). It should also be understood that all of the screens and other user interfaces described herein may occur within an iframe or other frame, division, section, or portion of a microsite landing page, such that the microsite landing page is always visible to the consumer. Alternatively, after the user initiates a transaction (e.g., by successfully submitting payment information through an iframe of the microsite landing page comprising the embedded virtual shopping cart), all further user interfaces of the virtual shopping cart (e.g., up-sell pages, order details page, confirmation page, etc.) may appear on one or more separate pages. In such an embodiment, only the initial user interface (e.g., comprising payment information inputs) appears embedded within the microsite landing page, and all subsequent user interfaces appear as their own webpages.

In an embodiment, when a potential consumer first initiates a transaction, for example, by submitting payment information on the microsite landing page through inputs of an embedded virtual shopping cart, the embedded virtual shopping cart validates the payment information. This validation may be performed prior to the payment information being submitted over network(s) 120 to server(s) 110 (e.g., via a POST request), for example, using a client-side script (e.g., JavaScript). Alternatively, the validation may be performed by server(s) 110, for example, using a servlet or other server-side application or module. In addition, in an embodiment, validation of some inputs may occur client-side, while validation of other inputs may occur server-side. In either implementation, if the virtual shopping cart is unable to validate at least a portion of the payment information, an error message may be reported to the consumer. This error message may be displayed within a portion of the embedded virtual shopping cart. Validation may also be performed on other inputs besides payment information, such as names, addresses (e.g., via an address validation service), and the like.

The virtual shopping cart widget may also allow, either as a system setting or user-defined parameter, consumer modification of individual sales transaction prior to transaction completion, including the alteration of line-item quantities, which may entail the replacement of products with alternatives (e.g., upgrades, downgrades) and changes to any dependent products (e.g., elimination of a buy-one-get-one-free offer). The widget may also include, either as system settings or user-defined parameters, the ability to “lock” in minimum purchase product and quantity levels selected by a consumer on the microsite landing page, and the ability to display options on the order review or edit pages providing the consumer with the option to start an order over or cancel the entire order.

FIG. 2 illustrates a process that may be suitable for a desktop browser application, in a scenario where the operator of the virtual shopping cart has disabled cart modification, order verification, and order on-hold support, but has enabled payment authorization. These may be user settings which are specified, for example, using the wizard or other user interfaces described elsewhere herein. The process 200 may begin in step 202 when a consumer requests a microsite. The microsite landing page, comprising a product or service offering and an embedded virtual shopping cart, is returned to the consumer in step 204. In step 206, the consumer chooses to purchase the product or service by inputting payment information into the embedded virtual shopping cart widget, and the system attempts to authorize payment. If payment authorization fails, the consumer may be returned to the landing page in step 204. If the payment is authorized, the consumer is provided with an up-sell (e.g., a sequential webpage) in step 208. In an embodiment, if a payment authorization service is unavailable in step 206, the system may treat the payment as approved. Alternatively, the system could treat the payment as failed.

In steps 208 and 210, a sequence of one or more up-sells may be presented to the consumer, according to one or more user-specified rules defining the interrelationships between the up-sells. Once the last up-sell is presented to the user in step 210, if any up-sells have been chosen by the consumer, payment authorization may again occur in step 220 for the selected one or more up-sells. If the payment authorization fails, the system may provide a verification in step 222. From the verification interface, the consumer may choose to continue in step 224, in which case, the consumer is returned to step 220 where payment authorization is reattempted. In an embodiment, in step 222 or 224, the user may provide different payment information for the reattempt. In step 224, the consumer may also choose to either cancel the order or start over. If the consumer chooses to cancel the order, the order is voided in step 230, and the status of the order is updated to “cancel” in step 232. If enabled, in step 234, a text or video chat feature may be provided to the consumer, through which the consumer may interact with a human operator and/or artificial intelligence, for example, to resolve issues that may be preventing completion of the transaction. If the consumer chooses to start over in step 224, the order is voided in step 236, and the status of the order is updated to “cancel” in step 238. The consumer is then returned to a home page in step 240, which may be the same as the landing page returned in step 204, or may be the marketer's home page.

In step 220, if the payment is authorized, or optionally if the payment authorization service is unavailable, the status of the order is updated to “complete” in step 260, and may be associated with an authorization code and/or transaction identifier. In step 262, the consumer's registered billing information may be updated (e.g., modified or added to), if the billing information supplied during the current transaction is different than previously stored billing information (e.g., billing information stored during a registration process or a previous transaction). Similarly, credit card information may be updated in step 264, if the credit card information supplied during the current transaction is different than previously stored credit card information. In step 266, a “thank you” page is provided to the consumer, and, if enabled, a confirmation email may be sent in step 268. The process 200 concludes in step 290.

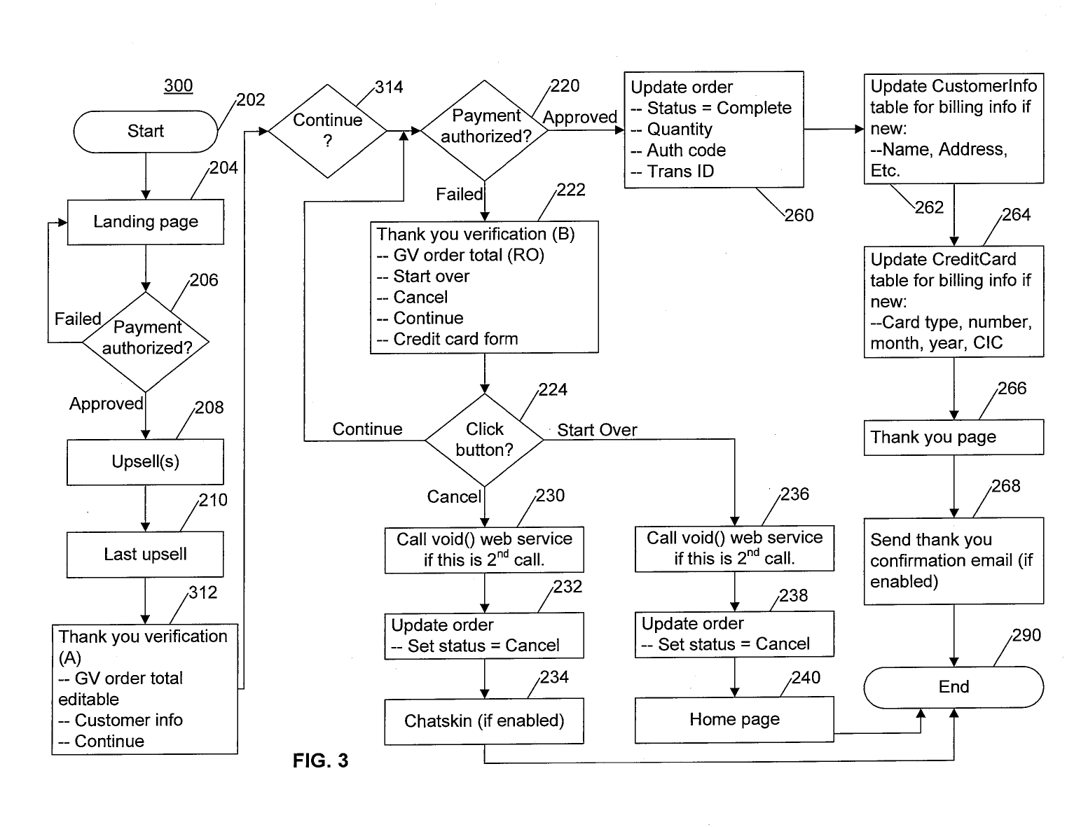

FIG. 3 illustrates an alternative process 300 that may be suitable for a desktop browser application, in a scenario where the operator of the virtual shopping cart has disabled order verification and order on-hold support, but has enabled cart modification and payment authorization. As illustrated, process 300 may be nearly identical to process 200. However, the consumer is provided a verification in step 312 which allows the consumer to modify his or her order prior to completion. Once the consumer is satisfied with the order, the consumer can confirm the order in step 314 and proceed to payment authorization in step 220, as previously described with respect to process 200.

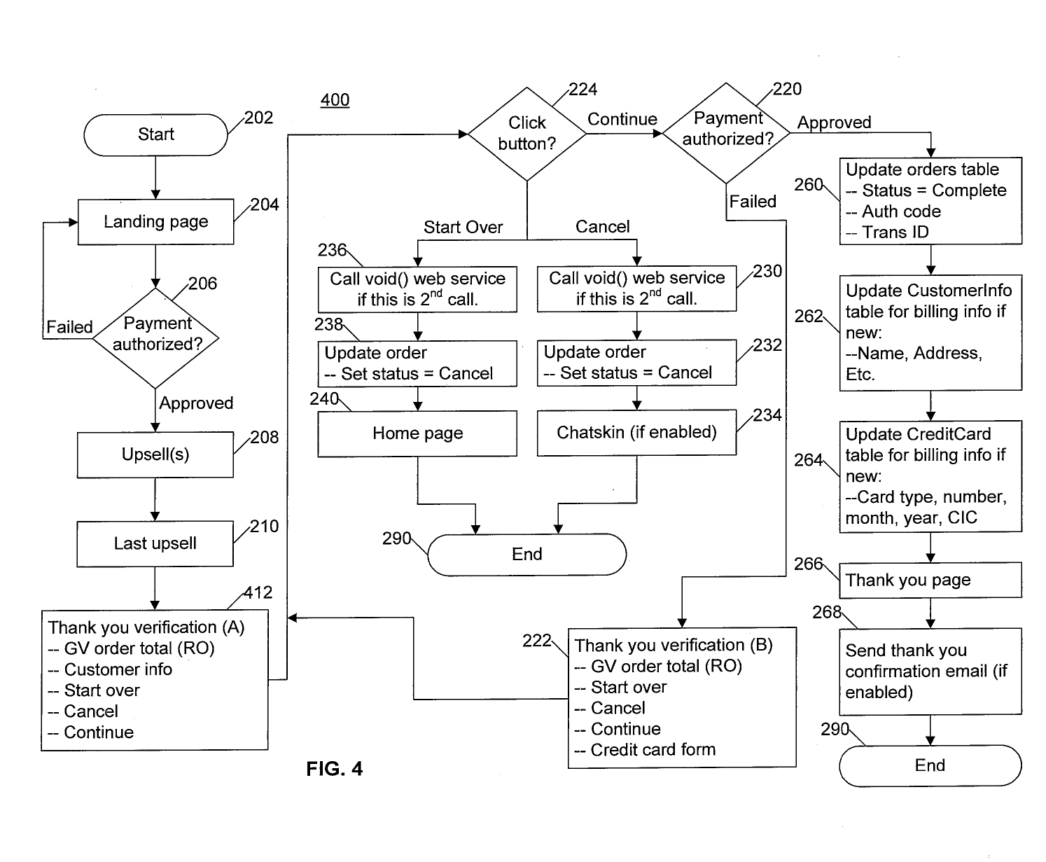

FIG. 4 illustrates an alternative process 400 that may be suitable for a desktop browser, in a scenario where the operator of the virtual shopping cart has disabled cart modification, but has enabled order verification, order on-hold support, and payment authorization. As illustrated, process 400 is similar to processes 200 and 300. The process begins similarly to process 200. However, after the last up-sell is presented in step 210, the consumer is provided with a verification screen in step 412 which permits the consumer to continue with the order or cancel or restart the order. If the consumer chooses to continue with the order in step 224, payment authorization is performed in step 220. If the payment authorization fails, the consumer is provided with a verification page in step 222, which allows the consumer to reattempt authorization (e.g., using the same or different credit card information), cancel the order, or restart the order. If the consumer chooses to cancel or restart the order, the process proceeds to steps 230 and 236, respectively, which have been previously described with respect to process 200. If payment authorization is successful, the process proceeds to step 260, as previously described with respect to process 200.

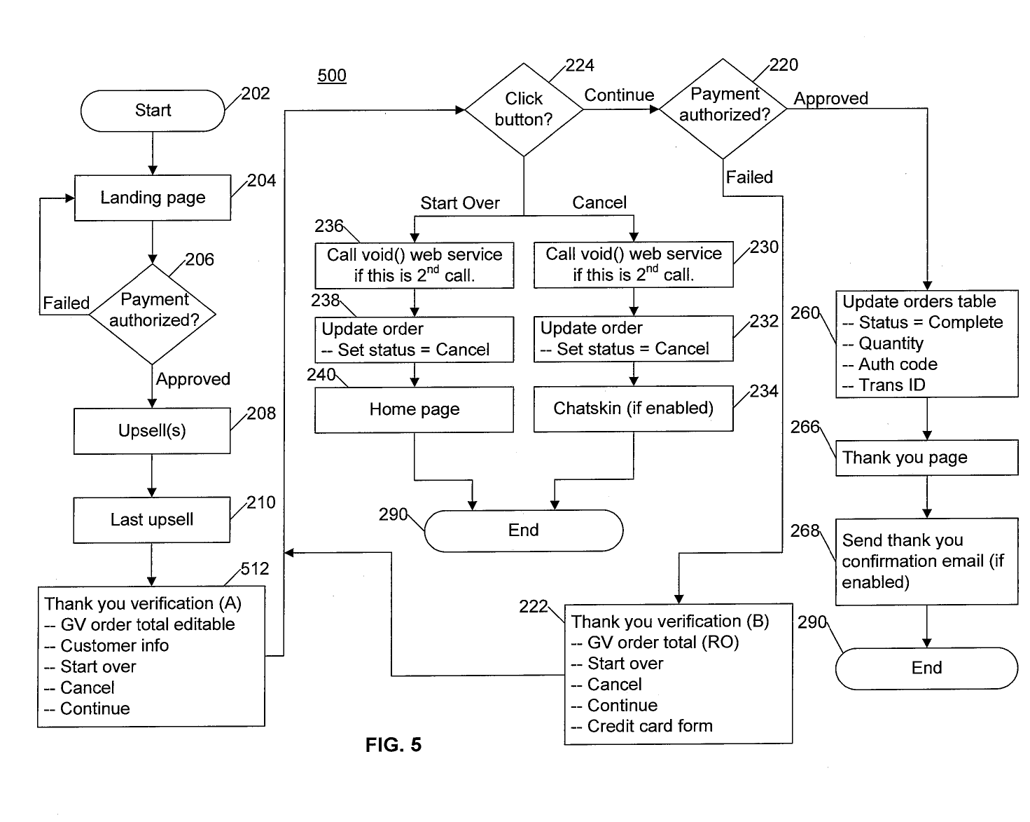

FIG. 5 illustrates an alternative process 500 that may be suitable for a desktop browser, in a scenario where the operator of the virtual shopping cart has enabled cart modification, order verification, and payment authorization. Process 500 is virtually identical to process 400. However, process 500 excludes the updates of consumers' billing information and credit card information in steps 262 and 264 of process 400.

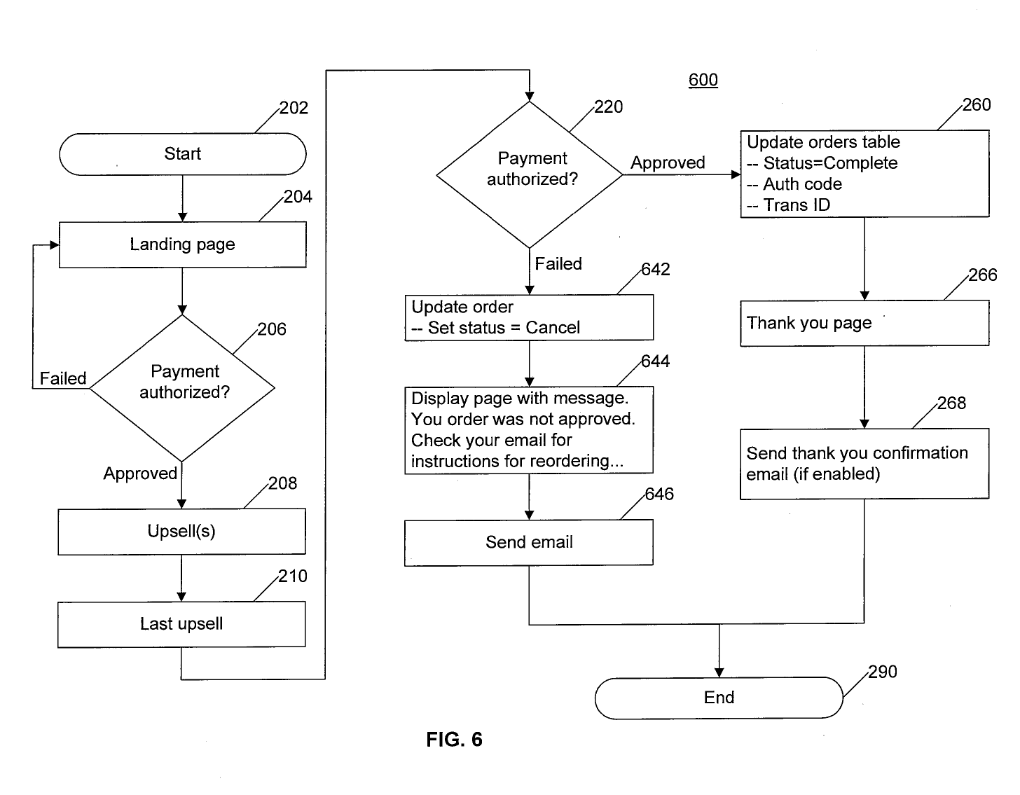

FIG. 6 illustrates an alternative process 600 that may be suitable for an order placed from a mobile device, in a scenario where the operator of the virtual shopping cart has enabled payment authorization. Process 600 essentially represents a simplified version of other processes described above. This simplified process provides a more mobile-friendly sequence of user interfaces for a mobile device user, since a mobile device may comprise less display area, processing, memory, and/or other resource capacity than is available to a typical desktop browser. Accordingly, process 600 provides a simpler set of steps for payment authorization in step 220. If payment authorization fails in step 220, the status of the order is updated to “cancel” and a message is displayed notifying the consumer that payment authorization failed. In an embodiment, the consumer may be provided instructions for reordering and/or may be sent an email or other notification in step 646 to confirm that the order failed and/or to provide instructions for reordering. If payment is approved in step 220, the order status is updated to “complete” in step 260. An authorization code and/or transaction identifier may also be associated with the order in step 260. In step 266, a “thank you” page is displayed to the consumer, and, if enabled, in step 268, a confirmation email or other notification may be sent to the consumer. Process 600 ends in step 290.

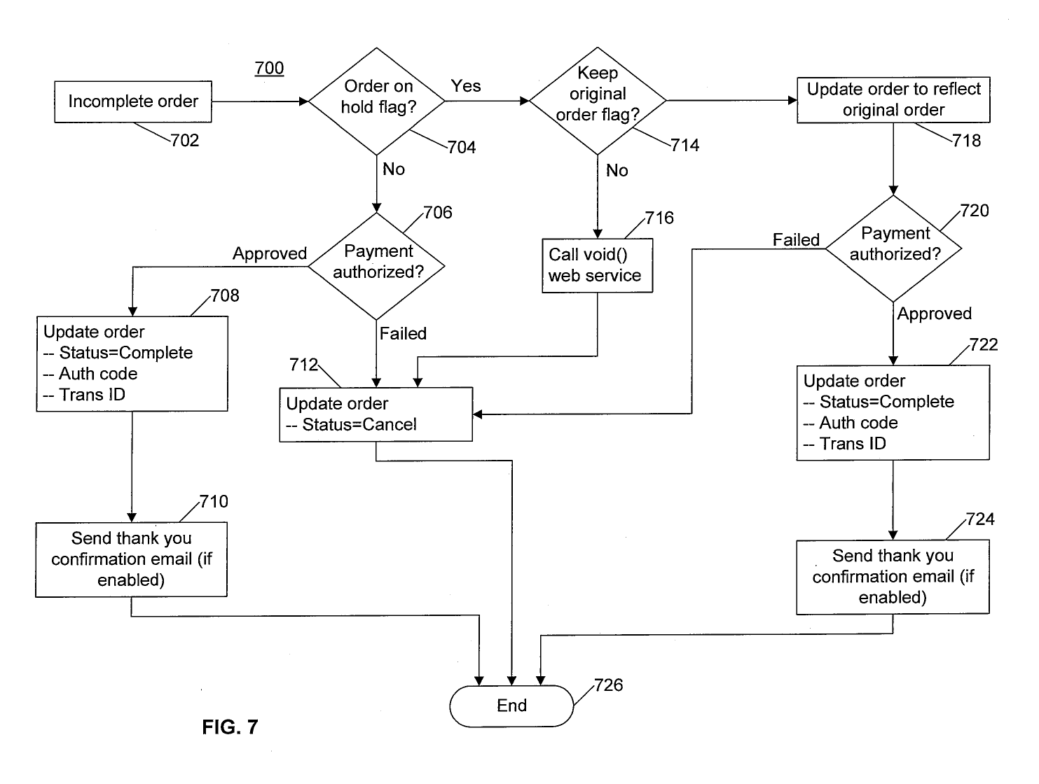

FIG. 7 illustrates a process 700 for handling an incomplete or abandoned order, according to an embodiment. Process 700 may be suitable in a scenario where an operator has enabled payment authorization. In step 702, an incomplete order is detected (e.g., by a thread checking for session timeouts). In step 704, it is determined whether the order has an on-hold indicator, such as a flag (e.g., integer, character, string, Boolean or other binary value, etc.). If the on-hold indication is not present (e.g., flag is set to false or zero), payment authorization is attempted in step 706. If the authorization is approved, the order status is set to “complete” and/or an authorization code and/or transaction identifier is associated with the order in step 708. If confirmation emails are enabled, in step 710, a confirmation email is sent to the consumer, and the process 700 ends in step 726. If payment authorization fails in step 706, the order status is set to “cancel” in step 712 and the process 700 ends in step 726.

If it is determined in step 704 that the order is on hold, in step 714, it is determined whether a keep-original-order indication (e.g., flag) is present. If the keep-original-order indication is not set, the order is voided in step 716, the order status is set to “cancel” in step 712, and the process ends in step 726. If the keep-original-order indication is set, the order is updated, in step 718, to reflect the original order (e.g., without any up-sells). Then, in step 720, payment authorization is attempted. If payment authorization fails, the order status is set to “cancel” in step 712, and the process ends in step 726. If payment authorization is successful, the order status is set to “complete” and/or an authorization code and/or transaction identifier is associated with the order in step 722. If enabled, a confirmation email is sent in step 724.

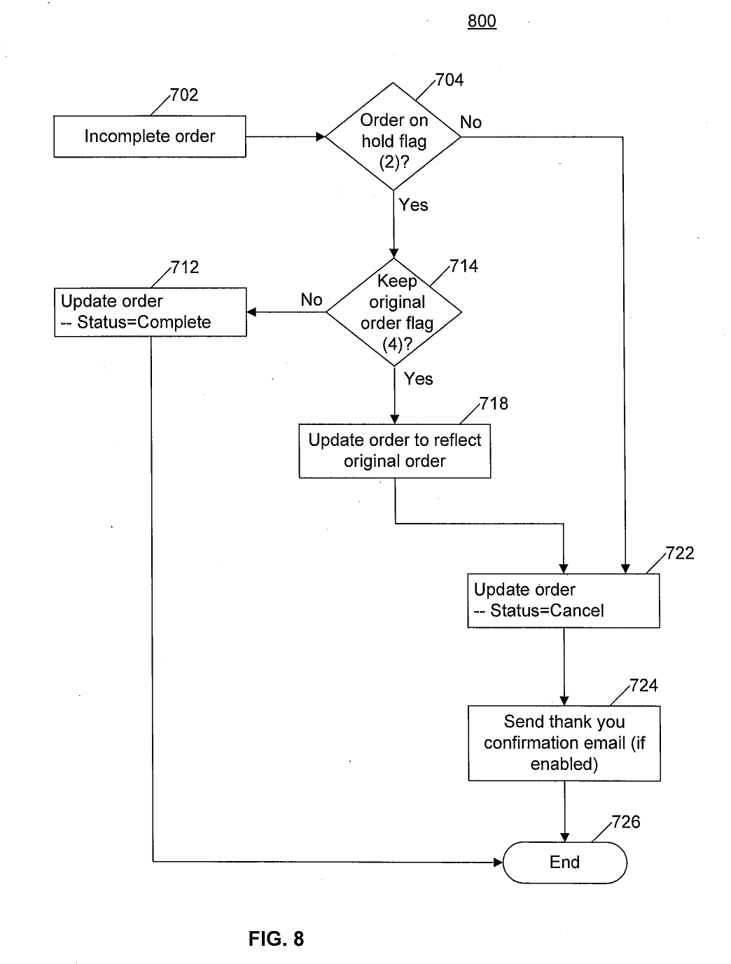

FIG. 8 illustrates an alternative process 800 for handling an incomplete or abandoned order, according to an embodiment. Process 800 may be suitable in a scenario where an operator has not enabled payment authorization. As with process 700, process 800 detects an incomplete order in step 704, determines the presence of an on-hold indication in step 704, and determines the presence of a keep-original-order indication in step 714. However, in contrast to process 700, process 800 does not utilize payment authorization. Thus, if the on-hold indication is detected and the keep-original-order indication is detected, the order is updated to reflect the original order in step 718, the order status is set to “complete” in step 722, if enabled, a “thank you” confirmation is sent to the consumer in step 724, and the process 800 ends in step 726. If the on-hold indication is detected, but the keep-original-order indication is not detected, the order status is set to “cancel” in step 712, and the process 800 ends in step 726. If the on-hold indication is not detected, the order status is set to “complete” in step 722, if enabled, a “thank you” confirmation is sent to the consumer in step 724, and the process 800 ends in step 726.

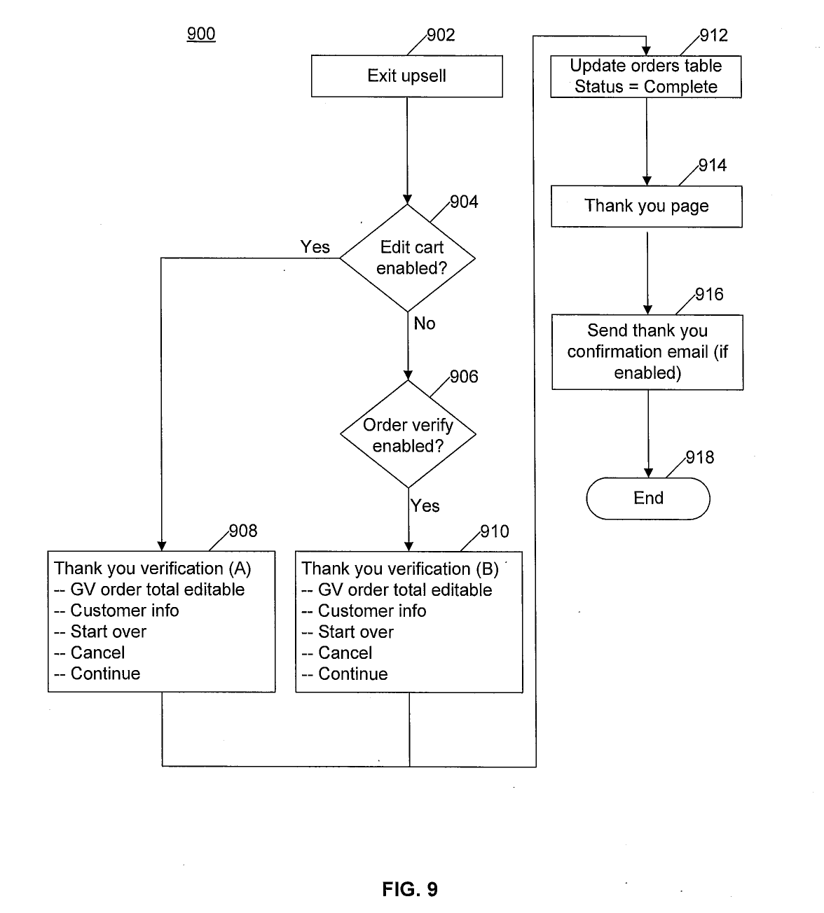

FIG. 9 illustrates a process 900 for exiting an up-sell, according to an embodiment. Process 900 may be suitable in a scenario where an operator of the virtual shopping cart has disabled payment authorization. In step 902, a consumer's exit or abandonment of an up-sell is detected. In step 904, it is determined whether the operator has enabled cart modification. If cart modification is enabled, in step 908, a verification screen is presented to the consumer which allows the consumer to modify the order. If cart modification is not enabled, in step 906, it is determined whether order verification is enabled. If order verification is enabled, in step 910, an order verification screen is presented to the consumer which does not allow the consumer to modify the order. If order verification is not enabled or after the verification screens are presented, and optionally approved, in steps 908 and 910, the process 900 proceeds to step 912. In step 912, the order status is set to “complete.” In step 914, a “thank you” page may be displayed to the consumer (e.g., as a pop-up), and, if enabled, in step 916, a confirmation email or other notification may be sent to the consumer. Process 900 then ends, as shown by step 918.

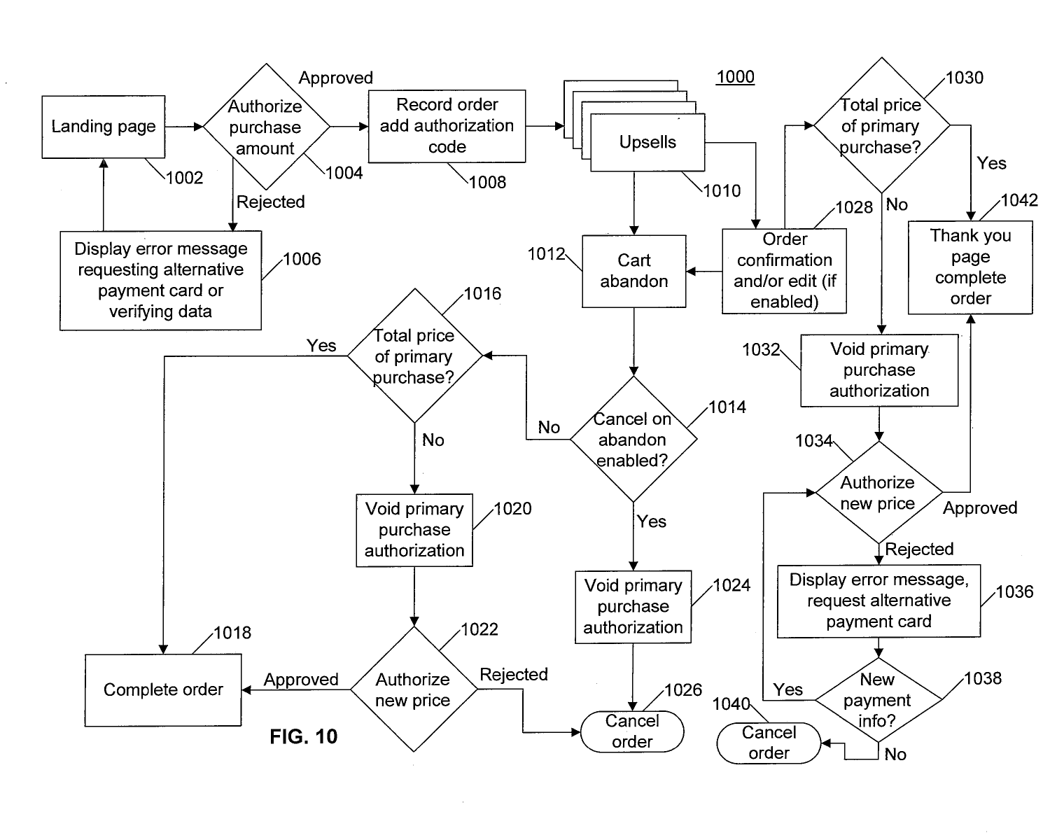

FIG. 10 illustrates a high-level flowchart for a payment card authorization process 1000, according to an embodiment. In step 1002, the microsite landing page with an embedded virtual shopping cart is requested and returned to a consumer. In step 1004, the system attempts to authorize a purchase amount for the consumer. For example, the system may utilize the Authorize.net online payment platform, and the payment amount may include all applicable shipping, handling, and taxes. In step 1006, if the purchase amount is rejected, an error message may be displayed to the consumer. In addition, the consumer may be prompted to supply alternative payment card information or verifying data. Authorization may be reattempted following entry of the alternative information or data.

In step 1008, if the purchase amount is approved, the order is recorded. In addition, an authorization code may be added to or otherwise associated with the order. In step 1010, one or more, optionally interrelated, up-sells are presented to the consumer (e.g., on sequential user interfaces). The consumer may choose to accept one or more of these up-sells (i.e., add the up-sell products/services to the order) or reject one or more of these up-sells. Following or during presentation of the up-sells, the order may be confirmed (if enabled) and/or edited (if enabled) by the consumer in step 1028, or may be abandoned (e.g., as determined by a session timeout) by the consumer in step 1012.

If the order is abandoned, the process 1000 determines in step 1014 whether or not abandoned orders should be canceled. This may be a user-specified setting. If it is determined that abandoned orders should not be canceled, in step 1016, it is determined whether the order price is equal to the purchase price of the primary product or service, i.e., the product or service that is the subject of the microsite landing page. If the order price is equal to the purchase price of the primary product or service, the order is completed in step 1018. However, if the order price is not equal to the purchase price of the primary product or service, the purchase authorization from step 1008 is voided in step 1020, and the process 1000 attempts to authorize a new purchase price equal to the purchase price of the primary product or service in step 1022. If this new purchase price is approved, the order is completed in step 1018. If, on the other hand, this new purchase price is rejected, the order is canceled in step 1026. If, in step 1014, it is determined that abandoned carts should be canceled, the purchase authorization from step 1008 is voided in step 1024, and the order is canceled in step 1026.

If the order is confirmed in step 1028, the order price is compared to the purchase price of the primary product or service in step 1030. If the two amounts are equal, a “thank you” page may be displayed to the consumer and/or a confirmation message may be sent to the consumer, and the order is completed in step 1042. However, if the two amounts are not equal, the purchase authorization from step 1008 is voided in step 1032. In step 1034, the system then attempts to authorize the new order price (e.g., which includes up-sells added to the order in step 1010). If the new order price is authorized, the order is complete in step 1042. Otherwise, in step 1036, an error message may be displayed, and the consumer may be prompted to supply alternative payment card information or verifying data, as in step 1006. If the consumer cannot or chooses not to supply alternative payment information or data, as determined in step 1038, the order is canceled in step 1040. Otherwise, payment authorization is attempted again in step 1034.

Generation and Management of Microsites

In an embodiment, server(s) 110 may be integrated with, comprise, or be commonly operated with server(s) 150. Server(s) 150 may comprise templates and/or wizards which allow a self-directed lay user (e.g., an administrator acting on behalf of a marketer) to quickly and efficiently generate one or thousands of ecommerce microsites. For instance, users may choose from a plurality of existing microsite templates comprising one or more creative elements, use their own templates, and/or upload their own creative elements to generate a new microsite or template. By way of illustration and not limitation, creative elements may include text, images, videos, inputs, frames (e.g., iframes), Flash media, or other embedded elements (e.g., embedded YouTube™ videos), and the like.

A wizard-driven interface may guide the user through a sequence of user interfaces which allow and/or require the user to enter data. For example, the wizard may allow the user to specify a product, a set of products, or a data source comprising products to be used as the subject(s) for one or more microsites. The wizard may also provide inputs for the user to specify a domain name, Internet Protocol (IP) address, and/or Secure Socket Layer (SSL) certificate for the microsite or set of microsites. The wizard may also incorporate or link to the wizard for generating a virtual shopping cart widget described above.

In an embodiment, microsites can be dynamically generated at the time that they are presented to a consumer. Alternatively or additionally, the microsites can be generated after a user has finished the creation process (e.g., after a user has completed the wizard). For example, the system may access a user-specified data feed of a marketer's products, and generate a microsite for each product in the data feed, or for a subset of products in the data feed. Each microsite may be generated according to a common template that was selected or generated by the user.

In an embodiment, the system retains the unique atomic nature of each sales transaction that is indicative of direct-response marketing, while allowing a consumer to review the aggregate sales session, i.e., the aggregation of sales transactions (e.g., including the items that are the subject of the sales transactions). For example, the system may retain the individual sales transactions as unique and separate entries in a central database while presenting them to the customer as an integrated sales order. The consumer may review the integrated sales order or sales session in a familiar tabular format. Additionally, the consumer may be allowed to modify individual sales transactions within the sales session.

In an embodiment, the system and methods emulate an in-person sales experience using a sequential, intelligent, up-selling process. For instance, a consumer may be led sequentially through two or more user interfaces (e.g., webpages, frames or tabs within a single webpage, etc.). Each user interface or some user interfaces, following the landing page, may present a sales item that is dependent on one or more sales items presented in a previous user interface. By way of illustration and not limitation, a consumer may land on a microsite for a suit. If the consumer proceeds with the purchase of the suit, subsequent user interface(s) may sequentially present the consumer with shirts, belts, ties, shoes, and/or socks.

In an embodiment, once a microsite has been generated, the user may manage the microsites individually and/or as a group or groups. For instance, the user may interact with a user interface of the system (e.g., hosted by server(s) 150) to enable and disable microsites. In the event that a user disables a microsite, the microsite may no longer be accessible to consumers. If a consumer attempts to access the microsite, an error message, error page, homepage, or other webpage may be returned in its place.

In an embodiment, microsites generated using the system may be integrated with a third-party application, such as a third-party ecommerce website. Each microsite associated with the third-party application may be co-branded for the third party. For example, the template used to generate the microsite, either dynamically or statically, may comprise a creative element comprising the co-branding. The server(s) 110 and/or 150 may receive or access a data source of products, maintained by the third party, and generate a co-branded microsite for each of the products, or a subset of products, in the data source. The server(s) 110 may collect transaction information from consumers' interactions with the microsites, and transmit such information to the third-party or other party for fulfillment. This transmission of information may occur for each individual transaction or as a batch of transactions, for example, using an API and/or XML or other format.

Additional Features

In certain embodiments, the system may comprise additional features. For instance, robust reporting and/or analytics may be provided, according to well-known techniques, for tracking performance and usage metrics for the collection of ecommerce microsites managed by the system. For example, the system may generate one or more reports comprising order details, order downloads, sales details, session data, and/or the like. The system may also provide affiliate program reporting and tracking, as well as free-form data reporting, and diagrams (e.g., Visio files) of up-sell process flows.

In addition, the system may provide robust support for Search Engine Marketing (SEM) and/or Search Engine Optimization (SEO) with one or more search engines or portals (e.g., Google™, Bing™, Yahoo™). SEM refers to the promotion of a website, such as the disclosed microsites, by increasing the website's visibility or ranking in search engine results pages. SEM may utilize SEO, which adjusts or writes microsite content with the objective of increasing the microsite's visibility or ranking on search engine results pages.

In an embodiment, the system provides support for social networking sites, such as Facebook™, Google+™, Twitter™, Pinterest™, and the like. For instance, the system may provide inputs (e.g., hyperlinks, buttons, etc.) with which a user may interact to share a microsite or virtual shopping cart with other social network users, for example, by posting a link and/or brief description of the microsite or virtual shopping cart on the user's social networking page, by “liking” the microsite or virtual shopping cart, or by otherwise indicating the user's interest in the microsite or virtual shopping cart.

In an embodiment, the system may provide a notification to a consumer and/or administrator/operator when a virtual shopping cart is abandoned. For example, the system may detect carts (e.g., using a monitoring thread), comprising one or more items, which have remained for a predetermined amount of time without becoming a completed transaction. The system may then send out an email to the consumer associated with the detected cart to remind the consumer about the cart and/or encourage the consumer to complete the transaction (e.g., with an up-sell). Alternatively or additionally, the system may either (1) automatically process only those transaction(s) selected by the consumer on the primary landing page of the microsite and cancel all other transactions (e.g., up-sells), (2) automatically cancel all transactions associated with the consumer's cart or session, or (3) automatically process all transactions associated with the consumer's cart or session. This may be a system setting or a user-defined parameter of a virtual shopping cart.

In an embodiment, the system supports A/B split testing. In A/B split testing, a microsite's or virtual shopping cart's content, behavior, and/or design may be modified, either client-side or server-side, and the effects of the modification can be measured. For example, a testing tool can be used to replace website content, such as the virtual shopping cart described above, with an alternative version or variant. The original or control version is then tested with the alternative versions, and the results are compared to determine which content better advances the defined goals of the microsite or cart (e.g., a conversion rate, up-sell rate, transaction totals). For example, one price or up-sell product or path may be presented to one subset of consumers, and a different price or up-sell product or path may be presented to a different subset of consumers. The results from the different subsets can be compared to determine which price or up-sell product or path resulted in the higher conversion rate, transaction totals, profit margin, etc. It should be understood that there can be any number of website variations and/or subsets, and that the selection of subsets of consumers may be random, based on round robin techniques, predefined criteria, and/or any other technique. For example, in one embodiment, the system (e.g., server(s) 110) may select and return different virtual shopping carts in response to requests for the same URL, based on a round-robin or other technique. In multivariate testing, dozens or hundreds of different microsite or virtual shopping cart variations can be mixed in a single test.

In an embodiment, the system may provide a wizard or other user interface or mechanism through which multiple variations of the microsite and/or shopping cart configuration may be created and deployed concurrently with individual version tracking. Such a mechanism may allow for testing, measurement, and reporting on the efficacy of individual or combinations of features and options. The mechanism may also allow a user, such as an administrator or operator, to activate or deactivate the instances at will and in a dynamic manner. Instances that are deployed and active may then be presented to consumers in a random fashion to ensure an even distribution of site impressions and a useful aggregation of statistical data.

In additional embodiments, the system may provide support for affiliate programs, analytics (e.g., Google Analytics™), and/or a plurality of consumer payment options (e.g., merchant account/gateway integration, such as Authorize.net, credit cards, PayPal™, e-checks, paper checks, different currencies, real-time credit card processing). For instance, affiliates or marketers may interface with the system via one or more APIs. In addition, third-party providers may be utilized to provide or assist in providing some functions. For example, PayPal™ may be used to provide payment authorization, and Amazon Web Services™ (AWS) may be used to provide a cloud computing platform for the various software modules and/or functions described herein. In addition, the virtual shopping cart generated by the system may comprise, be integrated with, or interface with (e.g., via one or more APIs) a billing platform. Alternatively, the virtual shopping cart may simply store transaction information and/or provide the information to a user of the virtual shopping cart (e.g., an operator of the microsite) for subsequent billing by the user (e.g., in the form of downloaded or otherwise transmitted XML documents). In this alternative embodiment, the virtual shopping cart may perform pre-authorization.

In an embodiment, the virtual shopping cart widget may be configured to accept coupons or gift certificates. This may be implemented as a user-defined parameter. Acceptable coupons may comprise a fixed discount amount per item or order, a fixed percentage discount per item or order, free or reduced shipping, and/or the like.

In an embodiment, the system may provide one or more video tutorials to users of the virtual shopping cart widgets and/or consumers interacting with the virtual shopping cart widget. The system may also provide support for multiple languages. For example, the language elements (e.g., text) of the virtual shopping cart widget and/or microsites can be provided in multiple languages, and a consumer may view the widget and/or microsites in a default or selected language (e.g., depending on the consumer's location or preference).

In an embodiment, the virtual shopping cart widget may have a save-and-exit feature, which may be a system setting or user-specified parameter. If such a feature is enabled, a consumer may save an incomplete transaction (e.g., by associating it with an identifier of the consumer and/or by utilizing cookies) and return to it later.

In an embodiment, the virtual shopping cart can be integrated with real-time inventory data. For example, the virtual shopping cart widget may have access to a data source (e.g., data source 140A) comprising real-time product inventory information for the primary product of a microsite and/or an up-sell product associated with the widget. The widget may utilize an API of the data source to retrieve the product inventory information, and use the product inventory information to determine how much product remains. For example, if no primary product remains in inventory, the widget may prevent a consumer from initiating or completing a transaction for the product, and optionally inform the consumer that the product is no longer available. As another example, if an up-sell product is no longer in inventory, the widget may prevent the up-sell from being presented to a consumer, or prevent the consumer from including the up-sell product in a transaction and optionally inform the consumer that the product is no longer available.

In an embodiment, the virtual shopping cart can also be integrated with real-time shipping information. For example, the virtual shopping cart widget may have access to a data source (e.g., data source 140B) comprising real-time shipping information. The widget may utilize an API of the data source to retrieve the shipping information. This shipping information, which may comprise tracking numbers, shipment status, and/or the like, can be presented to consumers through the widget. Additionally or alternatively, the widget may also utilize an API to transmit shipping information to a third-party shipper, for example, to initiate a shipment of a purchased product.

In an embodiment, the virtual shopping card widget may utilize pop-up messages for various notifications to a consumer. These pop-up messages may take the form of a virtual stick-up note. By way of illustration and not limitation, pop-up messages may be used for error messages (e.g., session timeout, invalid input, etc.), confirmation messages, “thank you” messages, and the like. A pop-up message may comprise images, inputs, and other elements besides just text. For example, a pop-up message could be utilized to provide the consumer with various offers or options, such as up-sell branching options.

Other features which may be utilized with certain embodiments disclosed herein, include the ability to easily and quickly replicate microsites, virtual shopping cart widgets, templates, creatives, and/or other data, the ability to define and assign different levels of login and/or view access for the various back-office functions described herein (e.g., virtual shopping cart and/or microsite generation and management), and order management to view, edit, export, and otherwise manage incomplete and/or completed orders received via virtual shopping carts managed through the system.

Example Computing Device

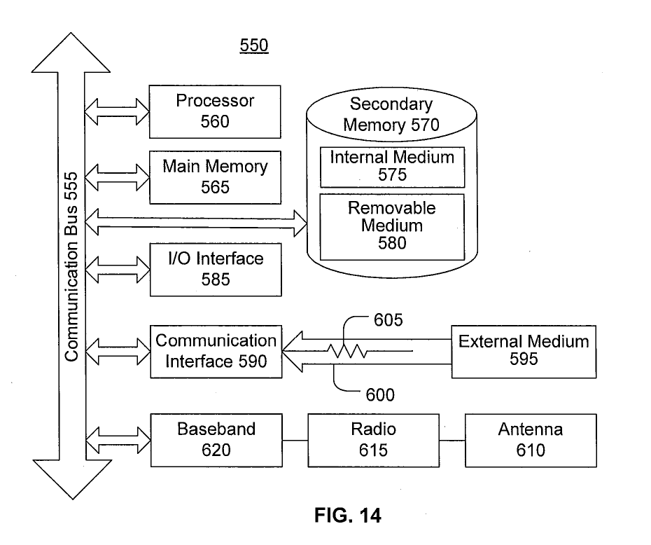

FIG. 14 is a block diagram illustrating an example wired or wireless system 550 that may be used in connection with various embodiments described herein. For example the system 550 may be used as or in conjunction with one or more of the mechanisms or processes described above, and may represent components of server(s) 110 and/or 150, user system(s) 130, and/or data source(s) 140. The system 550 can be a server or any conventional personal computer, or any other processor-enabled device that is capable of wired or wireless data communication. Other computer systems and/or architectures may be also used, as will be clear to those skilled in the art.

The system 550 preferably includes one or more processors, such as processor 560. Additional processors may be provided, such as an auxiliary processor to manage input/output, an auxiliary processor to perform floating point mathematical operations, a special-purpose microprocessor having an architecture suitable for fast execution of signal processing algorithms (e.g., digital signal processor), a slave processor subordinate to the main processing system (e.g., back-end processor), an additional microprocessor or controller for dual or multiple processor systems, or a coprocessor. Such auxiliary processors may be discrete processors or may be integrated with the processor 560. Examples of processors which may be used with system 550 include, without limitation, the Pentium® processor, Core i7® processor, and Xeon® processor, all of which are available from Intel Corporation of Santa Clara, Calif.

The processor 560 is preferably connected to a communication bus 555. The communication bus 555 may include a data channel for facilitating information transfer between storage and other peripheral components of the system 550. The communication bus 555 further may provide a set of signals used for communication with the processor 560, including a data bus, address bus, and control bus (not shown). The communication bus 555 may comprise any standard or non-standard bus architecture such as, for example, bus architectures compliant with industry standard architecture (ISA), extended industry standard architecture (EISA), Micro Channel Architecture (MCA), peripheral component interconnect (PCI) local bus, or standards promulgated by the Institute of Electrical and Electronics Engineers (IEEE) including IEEE 488 general-purpose interface bus (GPIB), IEEE 696/S-100, and the like.

System 550 preferably includes a main memory 565 and may also include a secondary memory 570. The main memory 565 provides storage of instructions and data for programs executing on the processor 560, such as one or more of the functions and/or modules discussed above. It should be understood that programs stored in the memory and executed by processor 560 may be written and/or compiled according to any suitable language, including without limitation C/C++, Java, JavaScript, Pearl, Visual Basic, .NET, and the like. The main memory 565 is typically semiconductor-based memory such as dynamic random access memory (DRAM) and/or static random access memory (SRAM). Other semiconductor-based memory types include, for example, synchronous dynamic random access memory (SDRAM), Rambus dynamic random access memory (RDRAM), ferroelectric random access memory (FRAM), and the like, including read only memory (ROM).

The secondary memory 570 may optionally include an internal memory 575 and/or a removable medium 580, for example a floppy disk drive, a magnetic tape drive, a compact disc (CD) drive, a digital versatile disc (DVD) drive, other optical drive, a flash memory drive, etc. The removable medium 580 is read from and/or written to in a well-known manner. Removable storage medium 580 may be, for example, a floppy disk, magnetic tape, CD, DVD, SD card, etc.

The removable storage medium 580 is a non-transitory computer-readable medium having stored thereon computer executable code (i.e., software) and/or data. The computer software or data stored on the removable storage medium 580 is read into the system 550 for execution by the processor 560.

In alternative embodiments, secondary memory 570 may include other similar means for allowing computer programs or other data or instructions to be loaded into the system 550. Such means may include, for example, an external storage medium 595 and an interface 590. Examples of external storage medium 595 may include an external hard disk drive or an external optical drive, or and external magneto-optical drive.

Other examples of secondary memory 570 may include semiconductor-based memory such as programmable read-only memory (PROM), erasable programmable read-only memory (EPROM), electrically erasable read-only memory (EEPROM), or flash memory (block oriented memory similar to EEPROM). Also included are any other removable storage media 580 and communication interface 590, which allow software and data to be transferred from an external medium 595 to the system 550.

System 550 may include a communication interface 590. The communication interface 590 allows software and data to be transferred between system 550 and external devices (e.g. printers), networks, or information sources. For example, computer software or executable code may be transferred to system 550 from a network server via communication interface 590. Examples of communication interface 590 include a built-in network adapter, network interface card (NIC), Personal Computer Memory Card International Association (PCMCIA) network card, card bus network adapter, wireless network adapter, Universal Serial Bus (USB) network adapter, modem, a network interface card (NIC), a wireless data card, a communications port, an infrared interface, an IEEE 1394 fire-wire, or any other device capable of interfacing system 550 with a network or another computing device.

Communication interface 590 preferably implements industry promulgated protocol standards, such as Ethernet IEEE 802 standards, Fiber Channel, digital subscriber line (DSL), asynchronous digital subscriber line (ADSL), frame relay, asynchronous transfer mode (ATM), integrated digital services network (ISDN), personal communications services (PCS), transmission control protocol/Internet protocol (TCP/IP), serial line Internet protocol/point to point protocol (SLIP/PPP), and so on, but may also implement customized or non-standard interface protocols as well.

Software and data transferred via communication interface 590 are generally in the form of electrical communication signals 605. These signals 605 are preferably provided to communication interface 590 via a communication channel 600. In one embodiment, the communication channel 600 may be a wired or wireless network, or any variety of other communication links. Communication channel 600 carries signals 605 and can be implemented using a variety of wired or wireless communication means including wire or cable, fiber optics, conventional phone line, cellular phone link, wireless data communication link, radio frequency (“RF”) link, or infrared link, just to name a few.

Computer executable code (i.e., computer programs or software) is stored in the main memory 565 and/or the secondary memory 570. Computer programs can also be received via communication interface 590 and stored in the main memory 565 and/or the secondary memory 570. Such computer programs, when executed, enable the system 550 to perform the various functions of the present invention as previously described.

In this description, the term “computer readable medium” is used to refer to any non-transitory computer readable storage media used to provide computer executable code (e.g., software and computer programs) to the system 550. Examples of these media include main memory 565, secondary memory 570 (including internal memory 575, removable medium 580, and external storage medium 595), and any peripheral device communicatively coupled with communication interface 590 (including a network information server or other network device). These non-transitory computer readable mediums are means for providing executable code, programming instructions, and software to the system 550.

In an embodiment that is implemented using software, the software may be stored on a computer readable medium and loaded into the system 550 by way of removable medium 580, I/O interface 585, or communication interface 590. In such an embodiment, the software is loaded into the system 550 in the form of electrical communication signals 605. The software, when executed by the processor 560, preferably causes the processor 560 to perform the inventive features and functions previously described herein.

In an embodiment, I/O interface 585 provides an interface between one or more components of system 550 and one or more input and/or output devices. Example input devices include, without limitation, keyboards, touch screens or other touch-sensitive devices, biometric sensing devices, computer mice, trackballs, pen-based pointing devices, and the like. Examples of output devices include, without limitation, cathode ray tubes (CRTs), plasma displays, light-emitting diode (LED) displays, liquid crystal displays (LCDs), printers, vacuum florescent displays (VFDs), surface-conduction electron-emitter displays (SEDs), field emission displays (FEDs), and the like.

The system 550 also includes optional wireless communication components that facilitate wireless communication over a voice and over a data network. The wireless communication components comprise an antenna system 610, a radio system 615 and a baseband system 620. In the system 550, radio frequency (RF) signals are transmitted and received over the air by the antenna system 610 under the management of the radio system 615.

In one embodiment, the antenna system 610 may comprise one or more antennae and one or more multiplexors (not shown) that perform a switching function to provide the antenna system 610 with transmit and receive signal paths. In the receive path, received RF signals can be coupled from a multiplexor to a low noise amplifier (not shown) that amplifies the received RF signal and sends the amplified signal to the radio system 615.

In alternative embodiments, the radio system 615 may comprise one or more radios that are configured to communicate over various frequencies. In one embodiment, the radio system 615 may combine a demodulator (not shown) and modulator (not shown) in one integrated circuit (IC). The demodulator and modulator can also be separate components. In the incoming path, the demodulator strips away the RF carrier signal leaving a baseband receive audio signal, which is sent from the radio system 615 to the baseband system 620.

If the received signal contains audio information, then baseband system 620 decodes the signal and converts it to an analog signal. Then the signal is amplified and sent to a speaker. The baseband system 620 also receives analog audio signals from a microphone. These analog audio signals are converted to digital signals and encoded by the baseband system 620. The baseband system 620 also codes the digital signals for transmission and generates a baseband transmit audio signal that is routed to the modulator portion of the radio system 615. The modulator mixes the baseband transmit audio signal with an RF carrier signal generating an RF transmit signal that is routed to the antenna system and may pass through a power amplifier (not shown). The power amplifier amplifies the RF transmit signal and routes it to the antenna system 610 where the signal is switched to the antenna port for transmission.

The baseband system 620 is also communicatively coupled with the processor 560. The central processing unit 560 has access to data storage areas 565 and 570. The central processing unit 560 is preferably configured to execute instructions (i.e., computer programs or software) that can be stored in the memory 565 or the secondary memory 570. Computer programs can also be received from the baseband processor 610 and stored in the data storage area 565 or in secondary memory 570, or executed upon receipt. Such computer programs, when executed, enable the system 550 to perform the various functions of the present invention as previously described. For example, data storage areas 565 may include various software modules (not shown).

Various embodiments may also be implemented primarily in hardware using, for example, components such as application specific integrated circuits (ASICs), or field programmable gate arrays (FPGAs). Implementation of a hardware state machine capable of performing the functions described herein will also be apparent to those skilled in the relevant art. Various embodiments may also be implemented using a combination of both hardware and software.

Furthermore, those of skill in the art will appreciate that the various illustrative logical blocks, modules, circuits, and method steps described in connection with the above described figures and the embodiments disclosed herein can often be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled persons can implement the described functionality in varying ways for each particular application, but such implementation decisions should not be interpreted as causing a departure from the scope of the invention. In addition, the grouping of functions within a module, block, circuit or step is for ease of description. Specific functions or steps can be moved from one module, block or circuit to another without departing from the invention.

Moreover, the various illustrative logical blocks, modules, functions, and methods described in connection with the embodiments disclosed herein can be implemented or performed with a general purpose processor, a digital signal processor (DSP), an ASIC, FPGA or other programmable logic device, discrete gate or transistor logic, discrete hardware components, or any combination thereof designed to perform the functions described herein. A general-purpose processor can be a microprocessor, but in the alternative, the processor can be any processor, controller, microcontroller, or state machine. A processor can also be implemented as a combination of computing devices, for example, a combination of a DSP and a microprocessor, a plurality of microprocessors, one or more microprocessors in conjunction with a DSP core, or any other such configuration.

Additionally, the steps of a method or algorithm described in connection with the embodiments disclosed herein can be embodied directly in hardware, in a software module executed by a processor, or in a combination of the two. A software module can reside in RAM memory, flash memory, ROM memory, EPROM memory, EEPROM memory, registers, hard disk, a removable disk, a CD-ROM, or any other form of storage medium including a network storage medium. An exemplary storage medium can be coupled to the processor such the processor can read information from, and write information to, the storage medium. In the alternative, the storage medium can be integral to the processor. The processor and the storage medium can also reside in an ASIC.

Any of the software components described herein may take a variety of forms. For example, a component may be a stand-alone software package, or it may be a software package incorporated as a “tool” in a larger software product. It may be downloadable from a network, for example, a website, as a stand-alone product or as an add-in package for installation in an existing software application. It may also be available as a client-server software application, as a web-enabled software application, and/or as a mobile application.

The above description of the disclosed embodiments is provided to enable any person skilled in the art to make or use the invention. Various modifications to these embodiments will be readily apparent to those skilled in the art, and the generic principles described herein can be applied to other embodiments without departing from the spirit or scope of the invention. Thus, it is to be understood that the description and drawings presented herein represent a presently preferred embodiment of the invention and are therefore representative of the subject matter which is broadly contemplated by the present invention. It is further understood that the scope of the present invention fully encompasses other embodiments that may become obvious to those skilled in the art and that the scope of the present invention is accordingly not limited.

What is claimed is:

1. A system for providing embedded payment functionality, the system comprising:
at least one hardware processor; and
at least one executable software module that, when executed by the at least one hardware processor,
receives configuration data, wherein the virtual shopping cart data comprises product data and up-sell data,
generates a uniform resource locator (URL) that is associated with the configuration data,
generates Hypertext Markup Language (HTML) code comprising the URL, wherein the HTML code is capable of being inserted within a HTML document, and,
dynamically generates a plurality of user interfaces based on the configuration data, wherein the plurality of user interfaces comprise a payment interface comprising inputs for payment information, and one or more up-sell interfaces comprising inputs for selecting one or more up-sell offers.

2. The system of claim 1, wherein the at least one executable software module further:
receives a request at the URL; and
provides one or more of the plurality of user interfaces in response to the request.

3. The system of claim 2, wherein the configuration data further comprises an identification of a template for a HTML document.

4. The system of claim 3, wherein the configuration data further comprises one or more user-definable elements of the template.

5. The system of claim 4, wherein the up-sell data comprises one or more branching rules, and wherein the at least one executable software module dynamically generates the one or more up-sell interfaces based on the one or more branching rules.

6. The system of claim 5, wherein the at least one executable software module dynamically generates the plurality of user interfaces sequentially.

7. The system of claim 6, wherein the one or more up-sell interfaces comprise a first user interface comprising a first up-sell offer and a second user interface comprising a second up-sell offer, and wherein the at least one executable software module determines whether to generate the second user interface based on the one or more branching rules and an interaction of a user with the first user interface.

8. The system of claim 1, wherein the HTML code comprises an inline frame code.

9. The system of claim 1, wherein the at least one executable software module further generates a unique identifier which identifies the configuration data, and wherein the URL comprises the unique identifier.

10. The system of claim 1, wherein the at least one executable software module receives at least a portion of the configuration data from one or more data feeds.

11. A method for providing embedded payment functionality, the method comprising, by at least one hardware processor:
receiving configuration data, wherein the configuration data comprises product data and up-sell data;
generating a uniform resource locator (URL) that is associated with the configuration data;
generating Hypertext Markup Language (HTML) code comprising the URL, wherein the HTML code is capable of being inserted within a HTML document; and
dynamically generating a plurality of user interfaces based on the configuration data, wherein the plurality of user interfaces comprise a payment interface comprising inputs for payment information, and one or more up-sell interfaces comprising inputs for selecting one or more up-sell offers.

12. The method of claim 11, further comprising:
receiving a request at the URL; and
providing one or more of the plurality of user interfaces in response to the request.

13. The method of claim 12, wherein the configuration data further comprises an identification of a template for a HTML document.

14. The method of claim 13, wherein the configuration data further comprises one or more user-definable elements of the template.

15. The method of claim 14, wherein generating the up-sell data comprises one or more branching rules, and wherein the method comprises dynamically generating the one or more up-sell interfaces based on the one or more branching rules.

16. The method of claim 15, comprising dynamically generating the plurality of user interfaces sequentially.

17. The method of claim 16, wherein the one or more up-sell interfaces comprise a first user interface comprising a first up-sell offer and a second user interface comprising a second up-sell offer, and wherein the method comprises determining whether to generate the second user interface based on the one or more branching rules and an interaction of a user with the first user interface.

18. The method of claim 11, wherein the HTML code comprises an inline frame code.

19. The method of claim 11, further comprising generating a unique identifier which identifies the configuration data, wherein the URL comprises the unique identifier.

20. The method of claim 11, further comprising receiving at least a portion of the configuration data from one or more data feeds.
